(19) United States
(12) Patent Application Publication
(10) Pub. No.: US 2026/0001041 A1
(43) Pub. Date: Jan. 1, 2026

(54) ARRANGEMENT FOR JOINING AND SEALING A METALLIC HYDROGEN SEPARATION MEMBRANE TO A METALLIC CONNECTOR

(71) Applicant: COMMONWEALTH SCIENTIFIC AND INDUSTRIAL RESEARCH, Australian Capital Territory (AU)

(72) Inventors: David Michael Viano, Victoria (AU); Matthew Langley, Queensland (AU); Sandy Edwards, Victoria (AU); Mark Andrew Kochanek, Victoria (AU)

(21) Appl. No.: 18/881,006

(22) PCT Filed: Jul. 6, 2023
(86) PCT No.: PCT/AU2023/050624

§ 371 Date: Jan. 3, 2025

(30) Foreign Application Priority Data
Jul. 7, 2022 (AU) 2022901905

(51) Int. Cl. B01D 65/00; B01D 53/14; B01D 63/06; B01D 71/02

(52) U.S. Cl. CPC B01D 65/003; B01D 53/14; B01D 63/061; B01D 63/063; B01D 71/022; B01D 2257/108; B01D 2313/04; B01D 2313/13

(57) ABSTRACT

The present invention provides a joining and sealing arrangement for joining and sealing together a hydrogen separation membrane to a metallic connector comprising:
a metallic hydrogen separation membrane mounted on or against a connector formation of the connector about a longitudinal axis, the connector being formed of a different metal to the hydrogen separation membrane, the hydrogen separation membrane having an outer diameter (D) about the longitudinal axis, the hydrogen separation membrane and the connector formation contacting at a connection interface in which an end face of the hydrogen separation membrane is proximate to, substantially abuts or overlaps an adjoining face of the connector formation;
a connection that connects the hydrogen separation membrane and the connector formation about the connection interface; and
a constriction collar configured to extend from at least the connection interface and extend axially over the hydrogen separation membrane relative to the longitudinal axis, the constriction collar comprising: an expansion section configured to axially extend over the hydrogen separation membrane relative to the longitudinal axis from a constriction end to an expanded diameter, the constriction end being configured to extend around the hydrogen separation membrane at or proximate the connection interface relative to the longitudinal axis and having an inner surface defining a constriction diameter (C) that is configured to extend around the outer surface of the hydrogen separation membrane, wherein the expansion section includes a transition section extending from the constriction end and comprises a curved surface having a transition radius of at least 0.1 D; and wherein the expansion section comprises an angled or curved section in which the diameter of the constriction collar expands from the constriction diameter C to the expanded diameter comprising at least 1.01 D.

The present application claims priority from Australian provisional patent application No. 2022901905 filed on 7 Jul. 2022, the contents of which are to be understood to be incorporated into this specification by this reference.

### TECHNICAL FIELD

The present invention generally relates to an arrangement for joining and sealing a metallic hydrogen separation membrane to a metallic connector. The present invention is particularly applicable for joining and sealing a vanadium-based tubular membrane to a stainless steel gas fitting. However, it should be appreciated that the present invention could be used to join and seal any metallic type of hydrogen separation membrane to any type of metallic fitting or body.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Hydrogen (H₂) does not occur naturally in great abundance, and in industrial practice it is produced by the conversion of a hydrocarbon fuel such as coal, petroleum or natural gas, through the decomposition of ammonia (NH₃), or from the electrochemical decomposition of water. Each of these production routes produces an impure gas stream containing H₂ plus unreacted feed gases (e.g., CH₄, H₂O, NH₃) and by-products such as CO₂, CO and N₂. For many applications, the H₂ must be separated from this mixed gas stream.

Membrane-based separation technology can be used for the separation of H₂ from mixed gas streams. Broadly speaking, a membrane is a near two-dimensional structure which is selectively permeable to one species. In the context of gas separation, a membrane allows one species to selectively permeate (H₂), while blocking other species (e.g. CO, CO₂, H₂O, N₂ etc.). Hydrogen-selective membranes can be created from inorganic, metallic or ceramic materials, each of which has characteristic hydrogen throughputs, operating temperatures and selectivity.

Palladium is the best known alloy membrane material, having an ability to permeate hydrogen between 300 to 600° C. whilst being tolerant to syngas species such as CO and H₂O. However, the high cost of palladium (AUD 100 to 130/g Pd (May 2022)), has driven research towards minimising its consumption, most notably through alloying with less-expensive metals, and minimising thickness by depositing very thin (<5 μm) layers on support structures with very fine pores.

A number of other metals exhibit very high hydrogen permeability, most notably vanadium, titanium, tantalum, niobium and zirconium. At 400° C., the hydrogen permeability of these metals is around two orders of magnitude greater than palladium, and the raw materials prices are significantly lower. Of these metals, vanadium has the widest alloying range, which means it has the widest scope for modifying the alloy properties to meet the demands of a vanadium-based membrane. One example of vanadium-based membranes is taught in the Applicant's United States patent publication No. US20150368762A1.

Vanadium-based membranes are typically connected and sealed with another tube or pipe to provide a flow path for the extracted H₂ and to prevent passage of non-H₂ gas species through the membrane. The sealing/joining of membranes to connections is crucial for the successful application of the V-based membrane technology in the separation of high purity hydrogen from a mixed gas feed containing hydrogen. In this regard, high purity hydrogen suitable for use in fuel-cell electric vehicles, FCEVs, require >99.97% purity as set out in ISO 14687 standard as well as maximum limits on individual gas species such as NH₃ and N₂. Failure of seals results in contamination of the hydrogen product, which means the membranes are no longer ‘fit for purpose’ for producing high purity hydrogen.

One connection and sealing technique for tubular vanadium-based membranes utilises brazing or welding connections between a V-based membrane to a metallic fitting, for example an end cap or connection fitting. One example of an arrangement that joins a vanadium-based membrane to a metallic fitting is taught in international patent publication No. WO2019000026A1 which teaches a brazing technique for joining and sealing a vanadium-based membrane to a metallic connector in which a filler or brazing metal is used to form a bridging section of filler metal between the vanadium-based membrane and connector over the connection interface.

An example of a welded arrangement that joins a vanadium-based membrane to a metallic fitting is taught in V. N. Alimov, I. V. Bobylev, A. O. Busnyuk, S. N. Kolgatin, S. R. Kuzenov, E. Yu. Peredistov, A. I. Livshits. International Journal of Hydrogen Energy, Volume 43, Issue 29, 19 Jul. 2018, Pages 13318-13327. The illustrated arrangement appears to use a small bridging collar which is placed over vanadium-based membrane and the abutting metallic fitting, which is then sealed, for example arc-welded, to join the vanadium-based membrane to the abutting metallic fitting.

However, vanadium-based hydrogen separation membrane tubes can have a linear (dimensional) expansion in the order of up to +5% and can have a volumetric expansion in the order of up to +15% when hydrogenated at conventional operating temperatures and pressures, compared to ambient conditions without hydrogen. Other group 5 metals have similar hydrogenation expansion properties. Neither of the aforementioned joining arrangements adequately account for the linear and volumetric expansion of these types of metallic hydrogen separation membranes when exposed to hydrogen and the strain and stress that can affect the integrity of the seal and join about the sealed joint. In each case, the brazed or welded joint is not protected from volumetric expansion of the metallic hydrogen separation membrane proximate that joint.

It would therefore be desirable to provide an improved and/or alternate method of connecting and sealing a vanadium or vanadium alloy based tubular membranes to an adjoining metallic tube or pipe.

### SUMMARY OF THE INVENTION

The present invention provides a joining and sealing arrangement, an associated method that includes a constriction collar for joining and sealing together a metallic hydrogen separation membrane to a metallic fitting, for example a stainless steel fitting, and a hydrogen separation membrane constriction collar.

A first aspect of the present invention provides a joining and sealing arrangement for joining and sealing together a hydrogen separation membrane to a metallic connector comprising:
a metallic hydrogen separation membrane mounted on or against a connector formation of the connector about a longitudinal axis, the connector being formed of a different metal to the hydrogen separation membrane, the hydrogen separation membrane having an outer diameter (D) about the longitudinal axis, the hydrogen separation membrane and the connector formation contacting at a connection interface in which an end face of the hydrogen separation membrane is proximate to, substantially abuts or overlaps an adjoining face of the connector formation;
a connection that connects the hydrogen separation membrane and the connector formation about the connection interface; and
a constriction collar configured to extend from at least the connection interface and extend axially over the hydrogen separation membrane relative to the longitudinal axis, the constriction collar comprising:
   an expansion section configured to axially extend over the hydrogen separation membrane relative to the longitudinal axis from a constriction end to an expanded diameter, the constriction end being configured to extend around the hydrogen separation membrane at or proximate the connection interface relative to the longitudinal axis and having an inner surface defining a constriction diameter (C) that is configured to extend around the outer surface of the hydrogen separation membrane,
   wherein the expansion section includes a transition section that extends from the constriction end, the transition section comprises a curved surface having a transition radius of at least 0.1 D,
   and wherein the expansion section comprises an angled or curved section in which the diameter of the constriction collar expands from the constriction diameter to the expanded diameter comprising at least 1.01 D.

The Inventors have found that a connection between metallic hydrogen separation membranes and a connector on its own can be prone to failure (resulting in leaks) and may not be as robust to the changes in membrane hydrogenation as desired. The joining and sealing arrangement of the first aspect of the present invention is designed to constrain the volumetric expansion of a metallic hydrogen separation (hydrogen selective) tubular membrane at or proximate to a connection junction between a hydrogen separation membrane and a connector when exposed to hydrogen. The constriction collar of this joining and sealing arrangement has an expansion section that transitions from a constriction diameter at a constriction end of the expansion section to a larger expanded diameter that allows the hydrogenated hydrogen separation membrane to expand, preferably gradually or progressively to expand, to its natural hydrogenated expanded diameter as the hydrogen separation membrane extends away from the connection between the hydrogen separation membrane and the connector along the longitudinal axis within the constriction collar.

The constriction end of the constriction collar can comprise a constriction section configured to move the expansion zone of the hydrogen separation membrane away from the connection interface/junction, thereby reducing the strain on that welded joint. In these embodiments, the constriction section is configured to axially extend over the hydrogen separation membrane from the connection end relative to the longitudinal axis to the expansion section, the constriction section having an inner surface that extends around the longitudinal axis at the constriction diameter. The transition section here extends from a transition region, area or point where the constriction section meets the expansion section.

It should be understood that the transition section comprises a curved surface that forms a transition surface from the constriction end/constriction section into the expansion section of the collar. The curved surface has a curve that follows a radial curve of at least 0.1 D. It should be appreciated that the curve typically comprises only a short segment or portion of that radial curve, with the curve joining the ends of and forming the transition surface between the constriction end/constriction section and the expansion section.

When hydrogen is introduced into a hydrogen separation membrane, the hydrogenated hydrogen separation membrane will expand within the constriction collar, and within the constriction section, that expansion will be constrained to the limits of the inner surface of the constriction collar. The collar of this first aspect of the present invention is configured to increase the size of the region in which constricting induced stress occurs along the hydrogen separation membrane. Rather than have stress concentrate at the interface or proximate to the connection interface, the stress loading is moved away from the connection interface and is spread along the constriction section. This reduces the stress loading on the connection interface, spreading the magnitude of stresses out across the constriction collar, rather than being at the connection interface point. Thus, the collar allows the seal between the hydrogen separation membrane and the connector to remain intact during changes in expansion and contraction experienced during changes in membrane hydrogenation.

It is to be understood that the outer diameter D is the outer diameter of the hydrogen separation membrane when the hydrogen separation membrane is in an un-hydrogenated state (i.e. not in a hydrogenated expanded state). The outer diameter depends on the size of membrane being used for hydrogen separation, and thus can have any suitable dimension. In embodiments, the outer diameter (D) can be from 2 to 25 mm. In some embodiments, the outer diameter (D) of the hydrogen separation membrane is between 5 mm to 20 mm, preferably 7 to 15 mm, and more preferably from 8 to 12 mm. In some embodiments, the outer diameter (D) of the hydrogen separation membrane is between 8.5 mm to 10 mm, preferably 9 to 10 mm, and more preferably about 9.5 mm. In some embodiments, the outer diameter (D) can be from 25 to 1000 mm, preferably from 25 to 100 mm. In other embodiments, the outer diameter (D) can be from 100 to 1000 mm, preferably from 200 to 800 mm.

The constriction diameter C is preferably sized to be between 0.95 D to 1.05 D. In embodiments, the constriction diameter comprises 0.97 D to 1.05 D, preferably 0.99 D to 1.05 D, and more preferably 1 D to 1.05 D. In some embodiments, the constriction diameter comprises 0.98 D to 1.05 D, preferably 0.999 D to 1.05 D. In some embodiments, the constriction diameter comprises 1 D to 1.04 D, preferably from 1 D to 1.02 D, and more preferably from 1.005 D to 1.01 D. In some embodiments, the constriction diameter is sized to provide a tight fit (0.95 D to 1 D) which requires force to fit the constriction end of the expansion section and (in applicable embodiments) the constriction section over the hydrogen separation membrane. In other embodiments, the constriction diameter is sized with a diameter greater than the outer diameter of the hydrogen separation membrane to allow the constriction end of the expansion section and (where applicable) the constriction section to be fitted, preferably slidingly fit, over the hydrogen separation membrane. In these embodiments, it should be understood that the constriction diameter of the inner surface of the constriction end and (in the applicable embodiments) the constriction section is preferably spaced apart from the outer surface of the hydrogen separation membrane (having outer diameter D) when the hydrogen separation membrane is in an un-hydrogenated state. The inner surface of the constriction section will abut or engage the outer surface of the hydrogen separation surface when the hydrogen separation membrane is in a hydrogenated state. The constriction diameter is preferably configured so that the inner surface of the constriction section is spaced apart from the hydrogen separation membrane in an un-hydrogenated state enabling the membrane to fit therein without interference. However, that gap is also preferably designed to be small enough that it can restrict hydrogen separation membrane expansion for a set distance from the connection interface, without the hydrogen separation membrane expanding significantly enough that the connection experiences strain or other unwanted forces that may otherwise affect the integrity of the seal created by that connection.

The inner surface of the constriction section is preferably substantially parallel spaced apart from the outer surface of the hydrogen separation membrane. In embodiments, the constriction diameter is greater than 1 D. This spacing provides at least a small gap enabling the hydrogen separation membrane and the connector to be fitted within the constriction collar. The constriction diameter typically has an upper limit on its ability to reduce, preferably substantially limit, movement of the hydrogen separation membrane about the connection between the hydrogen separation membrane and the connector during changes in expansion and contraction experienced during changes in membrane hydrogenation. In embodiments, the constriction diameter comprises greater than 1 D to 1.05 D, preferably greater than 1 D to 1.04 D, more preferably greater than 1 D to 1.02 D. In particular embodiments, the constriction diameter comprises 1.005 D to 1.01 D. In other embodiments, the constriction diameter is greater than 1 D to 1 D plus 0.05 mm, preferably greater than 1 D to 1 D plus 0.04 mm.

The expanded diameter D2 is selected to be a greater than the outer diameter D of the metallic hydrogen separation membrane. In this sense, the expanded diameter D2 is greater in size to the outer diameter D of the metallic hydrogen separation membrane when the metallic hydrogen separation membrane is in an unhydrogenated state. In embodiments, the expanded diameter D2 is at least 1.01 D, preferably at least 1.02 D. In some embodiments, the expanded diameter D2 is selected to be greater than the maximum diameter of the hydrogen separation membrane once hydrogenated (diameter D_{MH}). Hydrogen separation hydrogen-selective membrane tubes, such as vanadium-based hydrogen separation membranes, can volumetrically expand in the order of at least +10%, and more typically +13% when hydrogenated at conventional operating temperatures/pressures, compared to ambient conditions without hydrogen, with a linear expansion in one direction/axis of up to 5%—for example the diameter. In embodiments, the expanded diameter D2 is therefore at least 1.05 D to accommodate that linear expansion on hydrogenation of the hydrogen separation membrane. In embodiments, the expanded diameter D2 is at least 1.07 D, preferably at least 1.08 D, more preferably at least 1.11 D. In some embodiments, the expanded diameter D2 is at least 1.12 D, and preferably at least 1.2 D.

It should be appreciated that the expanded diameter D2 will also be greater than the constriction diameter C of the constriction section of the constriction collar. In this sense, the expanded diameter D2 is greater in size to the constriction diameter C. In embodiments, the expanded diameter D2 is at least 1.01 C, preferably at least 1.02 C. In embodiments, the expanded diameter D2 is at least 1.05 C to accommodate linear expansion on hydrogenation of the hydrogen separation membrane (as described above). In embodiments, the expanded diameter D2 is at least 1.07 C, preferably at least 1.08 C, more preferably at least 1.1 C. In some embodiments, the expanded diameter D2 is at least 1.12 C, and preferably at least 1.2 C.

The maximum diameter of the hydrogen separation membrane once hydrogenated, diameter D_{MH}, will also be greater than the constriction diameter C of the constriction section of the constriction collar. Similarly, the maximum diameter of the hydrogen separation membrane once hydrogenated, diameter D_{MH}, will also be greater than the outer diameter D of the metallic hydrogen separation membrane when the metallic hydrogen separation membrane is in an unhydrogenated state—as can be appreciated by the very nature of the hydrogenation process.

It should be appreciated that the diameter of the hydrogen separation membrane once hydrogenated, diameter DH, will vary across the joining and sealing arrangement depending on the location of the hydrogen separation membrane within the constriction collar. For example, within the constriction section, the diameter DH will be constrained to the constriction diameter C, whilst in the expansion section, the diameter DH will follow the diameter that it is constrained to until it reaches the maximum diameter of the hydrogen separation membrane once hydrogenated, diameter D_{MH}.

The expansion section can comprise a linear, curved or other shaped or contoured surface that generally expands from the constriction diameter to an expanded diameter. As explained above, the function of the expansion section is to provide a transition from a constriction diameter at a constriction end of that expansion section to a larger expanded diameter that allows the hydrogenated hydrogen separation membrane to expand, preferably gradually or progressively to expand, to its natural hydrogenated expanded diameter as the hydrogen separation membrane extends away from the connection between the hydrogen separation membrane and the connector along the longitudinal axis within the constriction collar. That shape can have an uneven or irregular shape or contour. However, it is preferable that the shape is generally regular and/or smooth, for example a region/surface following the transition section that comprises a linear expansion angle or a smooth curve. Where the expansion section comprises a curve, that curve can comprise a continuous curve that includes the curve of the transition section. In some embodiments, the transition section follows the same or similar curve as the whole surface of the expansion section and can share a common radius. Here the transition section and the angled or curved section of the expansion section following the transition section have the same or similar curve and can share a common radius.

The change from the constriction diameter to the expanded diameter in the expansion section can have any suitable shape or configuration. In some embodiments, the expansion section comprises a sloped or curved surface that extends from the transition section to the expanded diameter. In embodiments, the expansion section includes a tapered surface. In embodiments, the expansion section includes a contoured surface. For example, the diameter of the constriction collar can be configured to expand from the constriction diameter to an expanded diameter in the expansion section at an average expansion angle relative to the longitudinal axis comprising a non-zero angle of less than 17.5 degrees (i.e. an angle of greater than zero to 17.5 degrees), preferably from 0.5 to 6 degrees, more preferably from 3 to 5 degrees. In some embodiments, the diameter of the constriction collar can be configured to expand from the constriction diameter to an expanded diameter in the expansion section at an average expansion angle relative to the longitudinal axis comprising a non-zero angle of less than 15 degrees, preferably a non-zero angle of less than 10 degrees (i.e. an angle of greater than zero to 10 degrees), preferably an angle from 1 to 10 degrees, more preferably from 3 to 6 degrees, yet more preferably from 4 to 5 degrees. In other embodiments, the diameter of the constriction collar can be configured to expand from the constriction diameter to an expanded diameter in the expansion section at an average expansion angle relative to the longitudinal axis of at least 1 degree, preferably from 1 to 17.5 degrees, more preferably from 1 to 15 degrees, and yet more preferably from 2 to 7 degrees.

It should be appreciated that the average expansion angle comprises the average or mean rate of growth of the expansion section. In embodiments that the expansion section comprises a linear slope, this will substantially correspond with the angle of that linear slope relative to the longitudinal axis. In embodiments, that the expansion section is curved or otherwise non-linear, the average expansion angle is the average or mean angle formed from the surfaces within that expansion section relative to the longitudinal axis. For example, for a curved surface the average expansion angle will be the average angle of that curve. In embodiments, the average expansion angle is a non-zero angle of less than 17.5 degrees (i.e. an angle of greater than zero to 17.5 degrees), preferably from 0.5 to 6 degrees, more preferably from 3 to 5 degrees. In some embodiments, the average expansion angle is a non-zero angle of less than 15 degrees, preferably a non-zero angle of less than 10 degrees (i.e. an angle of greater than zero to 10 degrees), preferably from 1 to 10 degrees, more preferably from 3 to 6 degrees, yet more preferably from 4 to 5 degrees. In some embodiments, the average expansion angle is from 1 to 17.5 degrees, preferably 1 to 15 degrees, more preferably from 1 to 12 degrees, yet more preferably from 2 to 10 degrees, and yet more preferably from 2 to 7 degrees. In some embodiments, the average expansion angle is from 3 to 10 degrees, preferably from 3 to 7 degrees. In some embodiments, the expansion angle is at least 3 degrees, more preferably at least 5 degrees. In some embodiments, the average expansion angle is about 5 degrees. The length of the expansion section can then be determined by the expansion angle and the size of the expanded diameter that the taper must reach.

The length of the constriction section of the constriction collar is preferably selected to provide sufficient spacing of the connection interface from the expansion section, thereby reducing movement and other force transfer from the changes in expansion and contraction experienced during changes in membrane hydrogenation. In embodiments, the constriction section is configured to extend over the hydrogen separation membrane from the connection interface to the transition section for at least 0.25 D. In some embodiments the constriction section is configured to extend over the hydrogen separation membrane from the connection interface to the transition section for 0.25 D to 2D, preferably 0.25 D to 1.5 D, and more preferably 0.25 D to 1 D.

The expansion section provides a section where the hydrogen expansion of the hydrogen separation membrane can be preferably gradually expanded to the maximum expanded diameter D_{MH} over a length of the hydrogen separation membrane (relative to the longitudinal axis). Rapid expansion may still result in stress raising areas within the hydrogen separation membrane. Accordingly, the expansion section preferably extends at least 0.2 D relative to the longitudinal axis. A greater length can be advantageous. Thus, in embodiments, the expansion section extends at least 0.3 D, preferably at least 0.4 D, more preferably at least 0.5 D relative to the longitudinal axis.

It should also be appreciated that the transition section (and surface thereof) is located at the transition from the constriction diameter to the angled or curved section (i.e. tapered or curved surface) of the expansion section. In embodiments, the average expansion angle includes the curve provided by the transition section (and the comprising transition radius).

As detailed above, when hydrogen is introduced into the hydrogen separation membrane, the hydrogenated hydrogen separation membrane (tube) will expand within the constriction collar, and that expansion will be constrained to the limits of the inner surface of the constriction collar. In the constriction section, the outer surface of the hydrogen separation membrane will engage against the inner wall of that section. Similarly, the outer surface of the hydrogen separation membrane will engage against the inner wall of the expansion section until the point that the natural hydrogen expanded diameter of the hydrogen separation membrane is reached. At the transition section, the outer surface of the hydrogenated hydrogen separation membrane will have a complementary shape/curve around from the constriction diameter to the angled or curved section (i.e. tapered or curved surface) of the expansion section. Here the membrane expands from the constriction diameter to the angled or curved section of the expansion section of the collar following the shape of the transition section. The transition section therefore provides a curved surface that is configured to prevent a stress concentration point being formed when the inner surface of the constriction collar transitions from the constriction diameter to the angled or curved section (i.e. tapered or curved surface) of the expansion section. The curved surface of the transition section preferably has a curve radius of at least 0.1 D. In embodiments, the transition radius comprises from 0.1 D to 10 D, preferably from 0.5 D to 5 D, more preferably from 1 D to 5 D. In some embodiments, the transition radius comprises from 0.5 D to 10 D, more preferably from 1 D to 10 D, more preferably from 2D to 10 D.

The constriction collar is designed to extend from, and preferably over the connection interface of the hydrogen separation membrane. In embodiments, the constriction section of the constriction collar is configured to extend over the connection interface. In embodiments, the constriction collar can also be configured to extend over the connection interface, and over at least a portion of the connector. As taught above, the constriction diameter is preferably sized to be between 0.95 D to 1.05 D. In embodiments, the constriction diameter comprises 0.97 D to 1.05 D, preferably 0.99 D to 1.05 D, and more preferably 1 D to 1.05 D. In some embodiments, the constriction diameter comprises 0.98 D to 1.05 D, preferably 0.999 D to 1.05 D. In other embodiments, the constriction diameter comprises 1 D to 1.04 D, preferably from 1 D to 1.02 D, and more preferably from 1.005 D to 1.01 D. However in some embodiments, the inner surface of this part of the constriction section is preferably substantially parallel spaced apart from the outer surface of the connection interface and the connector. In these embodiments, the inner diameter of this part of the constriction section (the constriction diameter) is greater than 1 D to 1.05 D, preferably greater than 1 D to 1.04 D, and more preferably greater than 1 D to 1.02 D. In particular embodiments, the constriction diameter comprises 1.005 D to 1.01 D. In some embodiments, the inner diameter of this part of the constriction section (the constriction diameter) is at least greater than 1 D, more preferably greater than 1 D to 1 D plus 0.05 mm. The constriction section can therefore mechanically constrain any expansion of the connection interface during hydrogenation expansion and cycling. It should be appreciated that cycling refers to phases of expansion and contraction of the hydrogen separation membrane when in operation.

In embodiments, the constriction collar includes a collar fastening section configured to fasten onto a section of the connector. The constriction collar is preferably configured to extend over the connection interface to the constriction collar fastening section. Typically, the constriction collar extends from the constriction end over the connection interface to the constriction collar fastening section. The constriction collar fastening section typically includes a fastening formation configured to interconnect the constriction collar to a cooperative fastening formation of the connector. It should be appreciated that the cooperative fastening formation comprises a thread, interengageable rib and groove, rib and slot configurations, quick lock configurations or other suitable interengaging fastening configurations. In some embodiments, the fastening formation comprises a threaded connection which is configured to cooperatively fasten onto a thread located on the connector.

In embodiments, the constriction collar further comprises an end cap configured to form an end seal around the connector. The end cap preferably comprises a sealed cap into which the connector is fastened which fluidly seals one end of the hydrogen separation membrane. In some embodiments, the end cap extends from, preferably over, the connection interface and around an end of the connector that is distal to the connection interface. Typically, the end cap extends from the constriction section over the connection interface and around an end of the connector that is distal to the connection interface. The end cap preferably includes a fastening formation configured to interconnect the constriction collar to a cooperative fastening formation of the connector. It should be appreciated that the cooperative fastening formation comprises a thread, interengageable rib and groove, rib and slot configurations, quick lock configurations or other suitable interengaging fastening configurations. In some embodiments, the fastening formation comprises a threaded connection which is configured to cooperatively fasten onto a thread located on the connector.

In embodiments, the connector includes a tubular extension extending longitudinally away from the connection interface relative to the longitudinal axis. Here, the constriction collar includes a sealing section that is configured to extend over the tubular extension of the connector to a distal fastening end. Typically, the sealing section extends from the constriction section over the connection interface and to a distal fastening end. The constriction collar in this embodiment further includes a compression fitting configured to fasten to the distal fastening end of the sealing section and at least one ferrule configured to seal around a section of the tubular extension of the connector when the compression fitting is fastened onto the distal fastening end of the sealing section. The ferrule comprises a sealing member which is compressed by the compression fitting to create a fluid seal between the compression fitting and a portion of the tubular extension. The ferrule can have any suitable configuration and be made from any suitable material. In some embodiments, the at least one ferrule comprises a graphite ferrule. Similarly, the compression fitting can have any suitable configuration. In embodiments, the compression fitting comprises a sealing nut configured to be threadedly fastened to the distal fastening end of the sealing section. That sealing nut may comprise a compression type fitting or connection such as a Hy-Lok style compression fitting, or a Swagelok type fitting which seals on the distal fastening end of the sealing section. As with the previous embodiments, the sealing section may also include a fastening formation configured to interconnect the constriction collar to a cooperative fastening formation of the connector. Again, it should be appreciated that the cooperative fastening formation comprises a thread, interengageable rib and groove, rib and slot configurations, quick lock configurations or other suitable interengaging fastening configurations. In some embodiments, the fastening formation comprises a threaded connection which is configured to cooperatively fasten onto a thread located on the connector.

The constriction collar can have any suitable overall shape and configuration. In embodiments, the constriction collar comprises a tubular, preferably substantially cylindrical configuration. Similarly, the constriction collar can be formed from any suitable material. In embodiments, the constriction collar is comprised of at least one of: aluminium, an aluminium alloy, steel, stainless steel, nickel-chromium-iron alloy, brass, or a combination thereof.

The connector can be formed of/from any suitable metal or metal alloy onto which it is desired to mount the hydrogen separation membrane. In some embodiments, the connector is comprised of at least one of: steel, stainless steel, nickel-chromium-iron alloy, brass, Inconel, incoloy or a combination thereof. Examples of suitable materials include austenitic stainless steel, preferably a 300 series stainless steel, for example 303, 304, or 316 stainless steel.

The metallic hydrogen separation membrane comprises metal capable of hydrogen separation through the dissociative chemisorption of hydrogen on the surface, and then hydrogen diffusion through the metal lattice driven by the partial pressure drop to the opposite side of the membrane, followed by the re-combination of hydrogen atoms and desorption of hydrogen from the permeate side. Metallic membranes can produce hydrogen of high permeability and recovery in separating H₂/CO₂ or other H₂ containing gas mixtures. In embodiments, the hydrogen separation membrane comprises a group V (group 5) based metal or metal alloy, preferably a vanadium, tantalum or niobium metal or metal alloy, more preferably vanadium or a vanadium alloy. In some embodiments, the hydrogen separation membrane can be formed from vanadium or a vanadium alloy. Typically, the particular vanadium metal or alloy is selected based on its suitability for use in a membrane separation device. In some embodiments, the hydrogen separation membrane comprises a vanadium alloy that comprises vanadium, aluminium having a content of greater than 0 to 10 at %, and Ta content of less than 0.01 at %, having a ductility of greater than 10% elongation, preferably greater than 11% elongation. The vanadium alloy can further comprise a grain refining element selected from Ti, Cr, Fe, Ni or B having a content of greater than 0 to 5 at %, preferably between 0.2 and 4.5 at %. In some embodiments, the grain refining element has a content from 0.1 to 2 at %, preferably from 0.1 to 2 at %, and more preferably from 0.1 to 1 at %. In some embodiments, the hydrogen separation membrane is coated in a Pd based coating or a Pd—Au based coating.

The hydrogen separation membrane can have any suitable configuration. In exemplary embodiments, the hydrogen separation membrane is tubular. The tubular membranes can have any suitable dimensions as described previously. In some embodiments, the thin-walled tube comprises a tube having an outer diameter of between 2 to 25 mm, preferably between 3 and 20 mm and a wall thickness of from 0.05 to 1 mm, preferably from 0.1 to 1 mm, as discussed in more detail below. In some embodiments, the hydrogen separation membrane has a wall thickness of from 0.1 to 1 mm, preferably from 0.2 to 0.8 mm, more preferably from 0.2 to 0.5 mm.

The connector can have any suitable configuration. In many embodiments, the connector comprises a metallic fitting for example a connection fitting or end cap fitting, and preferably a metallic fluid connection fitting, more preferably a metallic gas connection fitting. In exemplary embodiments, the connector is tubular. The connector can have any suitable dimensions. In embodiments, the connector has a wall thickness of from 1 to 5 mm, preferably from 1 to 3 mm, more preferably from 1 to 2 mm.

The connector formation of the connector can have any suitable configuration. In embodiments, the connector formation comprises a sloped or bevelled section configured to receive the end section of the hydrogen separation membrane thereon. In exemplary embodiments, the connector formation comprises an angled sloped end of the connector formation having a reduced diameter. This forms a ramped or curved section onto which the hydrogen separation membrane can be mounted. In some embodiments, the sloped or bevelled section comprises a frustoconical shaped section. In other embodiments, the connection interface comprises a substantially planar end face of the hydrogen separation membrane being arrange in parallel abutting or adjoining relationship to a substantially planar adjoining face of the connector formation.

The connection between the hydrogen separation membrane and the connector can be any suitable gas sealing connection between those bodies, for example (but not limited to) welded connections, brazed connections, threaded connections, O-ring sealed connections or the like. In some embodiments, the connection comprises a welded connection or a brazed connection. In exemplary embodiments, the connection comprises a welded connection. The welded connection can be formed using any suitable welding technique for example a laser welded connection, an arc welded connection such as TIG, or electron beam welding. The welded connection preferably comprises a continuous weld which extends circumferentially around and over the connection interface. This forms a continuous welded seal over the connection interface between the hydrogen separation membrane and the connector formation. In some embodiments, the weld is autogenous (no filler material added). In other embodiments, a filler material is used in the welded connection, for example at least one of stainless steel, steel, aluminium-silicon, copper, copper alloy, gold-silver alloy, nickel alloy or silver.

The connector and the constriction collar are typically different bodies that are connected together through an interengageable fastening formation/arrangement. However, it should be appreciated that in some embodiments, the connector can form a fixed or integral part of the constriction collar.

A second aspect of the present invention provides a method of joining and sealing a hydrogen separation membrane to a metallic connector comprising:
mounting an end section of a hydrogen separation membrane on or against a connector formation of the connector, the connector being formed of a different metal to the hydrogen separation membrane, the hydrogen separation membrane having an outer diameter (D) about the longitudinal axis, the hydrogen separation membrane and the connector formation contacting at a connection interface in which an end face of the hydrogen separation membrane is proximate to, substantially abuts or overlaps an adjoining face of the connector formation;
joining the hydrogen separation membrane to the connector formation to join and seal the hydrogen separation membrane to the connector over the connection interface; and
locating a constriction collar over the hydrogen separation membrane to extend from at least the connection interface and extend axially over the hydrogen separation membrane relative to the longitudinal axis,
wherein the constriction collar comprises: an expansion section configured to axially extend over the hydrogen separation membrane relative to the longitudinal axis from a constriction end to an expanded diameter, the constriction end being configured to extend around the hydrogen separation membrane at or proximate to the connection interface relative to the longitudinal axis and having an inner surface defining a constriction diameter (C) that is configured to extend around the outer surface of the hydrogen separation membrane; the expansion section including a transition section that extends from the constriction end and comprises a curved surface having a transition radius of at least 0.1 D,
and wherein the expansion section comprises an angled or curved section in which the diameter of the constriction collar expands from the constriction diameter C to the expanded diameter comprising at least 1.01 D.

In some embodiments, this second aspect of the present invention provides a method of joining and sealing a hydrogen separation membrane to a metallic connector comprising:
mounting an end section of a hydrogen separation membrane on or against a connector formation of the connector, the connector being formed of a different metal to the hydrogen separation membrane, the hydrogen separation membrane having an outer diameter (D) about the longitudinal axis, the hydrogen separation membrane and the connector formation contacting at a connection interface in which an end face of the hydrogen separation membrane is proximate to, substantially abuts or overlaps an adjoining face of the connector formation;
joining the hydrogen separation membrane to the connector formation to join and seal the hydrogen separation membrane to the connector over the connection interface; and
locating a constriction collar over the hydrogen separation membrane to extend from at least the connection interface and extend axially over the hydrogen separation membrane relative to the longitudinal axis,
wherein the constriction collar comprises:
   an expansion section configured to axially extend over the hydrogen separation membrane relative to the longitudinal axis from a constriction end to an expanded diameter, the constriction end being configured to extend around the hydrogen separation membrane at or proximate to the connection interface relative to the longitudinal axis and having an inner surface defining a constriction diameter (C) that is configured to extend around the outer surface of the hydrogen separation membrane;
   wherein the expansion section includes a transition section that extends from the constriction end and comprises a curved surface having a transition radius of at least 0.1 D;
   and wherein the expansion section comprises an angled or curved section in which:
   the diameter of the constriction collar expands from the constriction diameter to the expanded diameter at an average expansion angle relative to the longitudinal axis of from greater than zero degrees to 17.5 degrees,
   the expanded diameter comprises at least 1.01 D, and
   the expansion section extends at least 0.1 D relative to the longitudinal axis.

In this method, firstly, the hydrogen separation membrane is joined to the metallic (for example stainless steel) connector using a suitable joining or connection method, for example a welding method such as laser welding, an arc welding method such as TIG, or electron beam welding. Secondly, a specially configured constriction collar is located proximate to or over the connection interface that is configured to extend over the hydrogen separation membrane to constrain expansion of the membrane proximate to that connection interface/joint during hydrogenation of the hydrogen separation membrane.

It should be appreciated that this second aspect of the present invention can include any one or a combination of the features described above in relation to the constriction collar described in relation to the first aspect of the present invention. Similarly, the constriction collar has the features defined in the following fifth aspect of the present invention, the disclosure of which should be understood to equally apply to this second aspect of the present invention. Furthermore, in embodiments, the method according to this second aspect of the present invention can use the joining and sealing arrangement according to the first aspect of the present invention and/or can be used to form the joining and sealing arrangement according to first aspect of the present invention.

Again, the constriction collar includes a constriction section that moves the expansion zone of the hydrogen separation membrane away from the welded junction, thereby reducing the strain on the welded joint and allowing the seal to remain intact during changes in expansion and contraction experienced during changes in membrane hydrogenation. In addition, the constriction collar includes an expansion section that allows the hydrogenated hydrogen separation membrane to expand, preferably gradually expand, to its natural hydrogenated expanded diameter as the hydrogen separation membrane extends away from the connection along the longitudinal axis X-X within the constriction collar.

The use of a constriction collar to protect the connection and seal has been found to produce a weld seal that can withstand the volumetric expansion to the Pd-coated hydrogen separation metal membrane when it absorbs hydrogen through the metal lattice during hydrogen diffusion. This occurs as part of the start-up of membrane operations when hydrogen partial pressure is gradually increased from zero to final operating condition. The fluid seal formed by the connection interface seal is also maintained during subsequent expansion and contraction of the tubular hydrogen separation metal membrane experienced during changes in hydrogenation, i.e. membrane cycling during operations (when varying operating hydrogen partial pressures and temperature) and desorbing hydrogen from the membrane prior to shutdown.

Again, the connector can include various sections that extend over the connection interface and over the connector. In some embodiments, the connector includes a tubular extension extending longitudinally away from the connection interface, and the constriction collar includes a sealing section that is is configured to extend over the tubular extension of the connector to a distal fastening end. In these embodiments, the method further comprises:
fastening a compression fitting to the distal fastening end of the sealing section, the compression fitting including at least one ferrule which seals around a section of the tubular extension of the connector when the compression fitting is fastened onto the distal fastening end of the sealing section.

As set out for the first aspect of the present invention, the ferrule comprises a sealing member that is compressed by the compression fitting to create a fluid seal between the compression fitting and a portion of the tubular extension. The ferrule can have any suitable configuration and can be made from any suitable material. In some embodiments, the at least one ferrule comprises a graphite ferrule. Similarly, the compression fitting can have any suitable configuration. In embodiments, the compression fitting comprises a sealing nut configured to be threadedly fastened to the distal fastening end of the sealing section. That sealing nut may comprise a compression type fitting or connection such as a Hy-Lok style compression fitting, or a Swagelok type fitting which seals on the distal fastening end of the sealing section. As with the previous embodiments, the sealing section may also include a fastening formation configured to interconnect the constriction collar to a cooperative fastening formation of the connector. Again, it should be appreciated that the cooperative fastening formation comprises a thread, interengageable rib and groove, rib and slot configurations, quick lock configurations or other suitable interengaging fastening configurations. In some embodiments, the fastening formation comprises a threaded connection which is configured to cooperatively fasten onto a thread located on the connector.

The connector and hydrogen separation membrane can have the features defined above for the first aspect of the present invention. The connector can be formed from any suitable metal, for example at least one of: steel, stainless steel, nickel-chromium-iron alloy, brass, Inconel, incoloy or a combination thereof.

Similarly, the hydrogen separation membrane can comprise any suitable hydrogen separation metal or alloy. In embodiments, the hydrogen separation membrane comprises a group V based metal or metal alloy, preferably a vanadium, tantalum or niobium metal or metal alloy, more preferably vanadium or a vanadium alloy. In some embodiments, the hydrogen separation membrane can be formed from vanadium or a vanadium alloy for example a vanadium alloy that comprises vanadium, aluminium having a content of greater than 0 to 10 at %, and Ta content of less than 0.01 at %, having a ductility of greater than 10% elongation, preferably greater than 11% elongation. In some embodiments, the vanadium alloy further comprises a grain refining element selected from Ti, Cr, Fe, Ni or B having a content of greater than 0 to 5 at %, preferably between 0.2 and 4.5 at %. The hydrogen separation membrane may also be coated in a Pd based coating or a Pd—Au based coating. In many embodiments, the hydrogen separation membrane is tubular. Similarly, in many embodiments, the connector is tubular. The connector formation can have any suitable configurations. In embodiments, the connector formation comprises a sloped or bevelled section configured to receive the end section of the hydrogen separation membrane thereon.

The connection between the hydrogen separation membrane and the connector can be any suitable gas sealing connection between those bodies, for example (but not limited to) welded connections, brazed connections, threaded connections, O-ring sealed connections or the like. In some embodiments, the connection comprises a welded connection or a brazed connection. In exemplary embodiments, the connection comprises a welded connection. The welded connection can be formed using any suitable welding technique for example a laser welded connection, or an arc welded connection such as TIG, or electron beam welding. The welded connection preferably comprises a continuous weld which extends circumferentially around and over the connection interface. This forms a continuous welded seal over the connection interface between the hydrogen separation membrane and the connector formation. In some embodiments the weld is autogenous (no filler wire added). In other embodiments, a filler material is used in the welded connection, for example at least one of aluminium-silicon, copper, copper alloy, gold-silver alloy, nickel alloy or silver.

As noted previously, the connector and the constriction collar are typically different bodies that are connected together through an interengageable fastening formation/arrangement. However, it should be appreciated that in some embodiments, the connector can form a fixed or integral part of the constriction collar.

A third aspect of the present invention also relates to a gas separation membrane system incorporating a hydrogen separation membrane joined and sealed to a connector formation using a joining and sealing arrangement according to the first aspect of the present invention and/or prepared by the method of according to the second aspect of the present invention.

The application of the sealing and joining arrangement of the present invention is to enable a hydrogen separation tubular membrane to be fitted into a catalytic membrane reactor (CMR) or membrane separator for use for selective separation of hydrogen gas from a mixed gas stream (with hydrogen and other gases), producing high purity hydrogen (suitable for FCEV refuelling applications) in the permeate stream from the membrane. The collar and associated method provide a means to join the hydrogen separation membrane to other metallic structures (tube connections, tube ends, etc) to form a hydrogen separation system, whilst maintaining sealing integrity, i.e. maintaining mechanical integrity/robustness through multiple cycles of operation.

A fourth aspect of the present invention provides at least one of a catalytic membrane reactor (CMR) or membrane separator including at least one hydrogen separation membrane joined and sealed to a connector using a joining and sealing arrangement according to the first aspect of the present invention and/or prepared by the method of according to the second aspect of the present invention.

The membrane of the present invention can have any suitable configuration selected based on the particular advantages that configuration can provide to a particular CMR or membrane separator configuration.

A CMR is essentially a two-dimensional device which channels syngas or alternatively ammonia (if catalytically cracking ammonia) along one dimension through a catalyst bed adjacent to a membrane. Flat membranes are easier and cheaper to produce than tubular membranes, but have a larger seal area, as the membranes are sealed around their outer edge. This sealing configuration provides a large sealing area and therefore can be prone to leaks between the raffinate and permeate gas streams. A tubular membrane enables a tubular CMR to be used, and therefore can reduce the seal area. In tubular reactors seals are only required at each end of the tube. The joining and sealing method of the present invention can be used to provide these seals. Similar considerations are also applicable for membrane separator configurations.

In some embodiments, the hydrogen separation membranes of the present invention have a tubular configuration, preferably comprising tubes. The tubular membrane can have any suitable dimensions as described above. In some embodiments, the thin-walled tube comprises a tube having an outer diameter of between 2 to 25 mm, preferably between 3 and 20 mm and a wall thickness of from 0.05 to 1 mm, preferably from 0.1 to 10 mm. In exemplary bodies, the tubular membrane comprises a thin-walled tube that comprises a vanadium alloy comprising vanadium, aluminium having a content of greater than 0 to 10 at %, and Ta content of less than 0.01 at %, having a ductility of greater than 10% elongation, preferably greater than 11% elongation. In some embodiments, the hydrogen separation membrane is coated in a Pd based coating or a Pd—Au based coating.

It should be appreciated that the alloying content and mechanical properties of the hydrogen separation membrane of the fourth aspect of the present invention is the same as described above for the first and second aspects of the present invention and should be understood to equally apply to this aspect of the present invention.

A fifth aspect of the present invention provides a hydrogen separation membrane constriction collar configured to extend over a hydrogen separation membrane, the constriction collar being configured to extend from a connection interface between the hydrogen separation membrane and a connector and over the hydrogen separation membrane, the constriction collar having a longitudinal axis, and comprising:
an expansion section configured to axially extend over the hydrogen separation membrane relative to the longitudinal axis from a constriction end to an expanded diameter, the constriction end defining a constriction diameter (C) that is configured to extend around the hydrogen separation membrane at or proximate to the connection interface relative to the longitudinal axis and having an inner surface that extends around the outer surface of the hydrogen separation membrane,
wherein the expansion section includes a transition section that extends from the constriction end and comprises a curved surface having a transition radius of at least 0.1 C;
and wherein the expansion section comprises an angled or curved section in which the diameter of the constriction collar expands from the constriction diameter to the expanded diameter at an average expansion angle relative to the longitudinal axis comprising a non-zero angle less than 17.5 degrees, and the expanded diameter comprises at least 1.01 C.

As with the first aspect, the Inventors have found that a connection between metallic hydrogen separation membranes and a connector on its own can be prone to failure (resulting in leaks) and may not be as robust to the changes in membrane hydrogenation as desired. The constriction collar of this fifth aspect of the present invention is designed to constrain the volumetric expansion of a metallic hydrogen separation (hydrogen selective) tubular membrane at and proximate to a connection junction between a hydrogen separation membrane and a connector when exposed to hydrogen. The constriction collar has an expansion section that transitions from a constriction diameter at a constriction end of that expansion section to a larger expanded diameter that allows the hydrogenated hydrogen separation membrane to expand, preferably gradually/progressively to expand, to its natural hydrogenated expanded diameter as the hydrogen separation membrane extends away from the connection between the hydrogen separation membrane and the connector along the longitudinal axis within the constriction collar.

It is to be understood that the constriction collar in the joining and sealing arrangements of the first aspect of the present invention share a number of similar features to the constriction collar that will be described for this fifth aspect of the present invention and that the following disclosure of the constriction collar of the fifth aspect of the present invention equally applies to like features of the constriction collar that comprises a feature of the joining and sealing arrangements of the first aspect of the present invention, and vice versa.

In many embodiments, the constriction end of the constriction collar includes a constriction section configured to move the expansion zone of the hydrogen separation membrane away from the connection interface/junction, thereby reducing the strain on the welded joint. In these embodiments, the constriction section is configured to axially extend over the hydrogen separation membrane from the connection end relative to the longitudinal axis to the expansion section, the constriction section having an inner surface that extends around the longitudinal axis at the constriction diameter. The transition section extends from the transition region, area, point or the like between the constriction section and the expansion section. The transition section here extends from a transition region, area or point where the constriction section meets the expansion section.

It should be understood that the transition section comprises a curved surface that forms a transition surface between the constriction end/constriction section to the expansion section of the collar. That curved surface has a curve that follows a radial curve of at least 0.1 C. It should be appreciated that the curve typically comprises only a short segment or portion of that radial curve, with the curve joining the ends of and forming the transition surface between the constriction end/constriction section and the angled or curved section of the expansion section.

It should also be understood that outer diameter D is the outer diameter of the hydrogen separation membrane when the hydrogen separation membrane is in an un-hydrogenated state (i.e. not in a hydrogenated expanded state). The outer diameter depends on the size of membrane being used for hydrogen separation, and thus can have any suitable dimension.

The constriction diameter C is preferably sized to be between 0.95 D to 1.05 D. In embodiments, the constriction diameter comprises 0.97 D to 1.05 D, preferably 0.99 D to 1.05 D, and more preferably 1 D to 1.05 D. In some embodiments, the constriction diameter comprises 0.98 D to 1.05 D, preferably 0.999 D to 1.05 D. In some embodiments, the constriction diameter comprises 1 D to 1.04 D, preferably from 1 D to 1.02 D, and more preferably from 1.005 D to 1.01 D.

The length of the constriction section of the constriction collar is preferably selected to provide sufficient spacing of the connection interface from the expansion section, thereby reducing movement and other force transfer from the changes in expansion and contraction experienced during changes in membrane hydrogenation. In embodiments, the constriction section is configured to extend over the hydrogen separation membrane from the connection interface to the transition section for at least 0.25 C. In some embodiments, the constriction section is configured to extend over the hydrogen separation membrane from the connection interface to the transition section for 0.25 C to 2 C, preferably 0.25 C to 1.5 C, and more preferably 0.25 C to 1 C.

The expanded diameter D2 is selected to be greater than the outer diameter D of the metallic hydrogen separation membrane when the metallic hydrogen separation membrane is in an unhydrogenated state, and also the constriction diameter C. In embodiments, the expanded diameter D2 is at least 1.01 C, preferably at least 1.02 C. In some embodiments, the expanded diameter D2 is selected to be greater than the maximum diameter of the hydrogen separation membrane once hydrogenated, diameter D_{MH}. Hydrogen separation (hydrogen-selective) membrane tubes, such as vanadium-based hydrogen separation membranes, can volumetrically expand in the order of at least +10%, and more typically +13% when hydrogenated at conventional operating temperatures/pressures, compared to ambient conditions without hydrogen, with a linear expansion in one direction/axis of up to 5%—for example the diameter. In embodiments, the expanded diameter D2 is therefore at least 1.05 D to accommodate that linear expansion upon hydrogenation of the hydrogen separation membrane. In embodiments, the expanded diameter D2 is at least 1.07 C, preferably at least 1.08 C, more preferably at least 1.1 C. In some embodiments, the expanded diameter D2 is at least 1.12 C, and preferably at least 1.2 C.

Again, the maximum diameter of the hydrogen separation membrane once hydrogenated, diameter D_{MH}, is greater than the constriction diameter C of the constriction section of the constriction collar. Similarly, the maximum diameter of the hydrogen separation membrane once hydrogenated, diameter D_{MH}, is greater than the outer diameter D of the metallic hydrogen separation membrane when the metallic hydrogen separation membrane is in an unhydrogenated state—as can be appreciated by the very nature of the hydrogenation process.

As described for the first aspect, the expansion section can comprise a linear, curved or other shaped or contoured surface that generally expands from the constriction diameter to an expanded diameter. That shape can have an uneven or irregular shape or contour. However, it is preferable that the shape is generally regular and/or smooth, for example at a linear expansion angle or a smooth curve. Where the expansion section comprises a curve, that curve can comprise a continuous curve that includes the transition section. In some embodiments, the transition section follows the same or similar curve as the whole surface of the expansion section and can share a common radius. Here the transition section and the angled or curved section of the expansion section following the transition section have the same or similar curve and can share a common radius.

The change from the constriction diameter to the expanded diameter in the expansion section can have any suitable shape. In some embodiments, the expansion section comprises a sloped or curved surface from the transition section to the expanded diameter. In embodiments, the expansion section includes a sloped or tapered surface. For example, the diameter of the constriction collar can be configured to expand from the constriction diameter to an expanded diameter in the expansion section at an average expansion angle relative to the longitudinal axis comprising a non-zero angle of less than 17.5 degrees (i.e. an angle of greater than zero to 17.5 degrees), preferably from 0.5 to 6 degrees, more preferably from 3 to 5 degrees. In some embodiments, the diameter of the constriction collar can be configured to expand from the constriction diameter to an expanded diameter in the expansion section at an average expansion angle relative to the longitudinal axis comprising a non-zero angle of less than 15 degrees, preferably a non-zero angle of less than 10 degrees (i.e. an angle of greater than zero to 10 degrees), preferably an angle from 1 to 10 degrees, more preferably from 3 to 6 degrees, yet more preferably from 4 to 5 degrees. In some embodiments, the diameter of the constriction collar can be configured to expand from the constriction diameter to an expanded diameter in the expansion section at an average expansion angle relative to the longitudinal axis of at least 1 degree, typically from 1 to 17.5 degrees, preferably 1 to 15 degrees, and yet more preferably from 2 to 7 degrees.

It should be appreciated that the average expansion angle comprises the average or mean rate of growth/expansion of the expansion section relative to the longitudinal axis. In embodiments where the expansion section comprises a linear slope, this will substantially correspond with the angle of that linear slope. In other embodiments where the expansion section is curved or otherwise non-linear, the average expansion angle will be the average or mean angle formed from the surfaces within that expansion section. For example, for a curved surface the average expansion angle will be the average angle of that curve.

In embodiments, the average expansion angle is a non-zero angle of less than 17.5 degrees (i.e. an angle of greater than zero to 17.5 degrees), preferably from 0.5 to 6 degrees, more preferably from 3 to 5 degrees. In some embodiments, the average expansion angle is a non-zero angle of less than 15 degrees, preferably a non-zero angle of less than 10 degrees (i.e. an angle of greater than zero to 10 degrees), preferably from 1 to 10 degrees, more preferably from 3 to 6 degrees, yet more preferably from 4 to 5 degrees. In some embodiments, the average expansion angle is from 1 to 17.5 degrees, preferably 1 to 15 degrees, more preferably from 1 to 12 degrees, yet more preferably from 2 to 10 degrees, and yet more preferably from 2 to 7 degrees. In some embodiments, the average expansion angle is from 3 to 10 degrees, preferably from 3 to 7 degrees. In some embodiments, the expansion angle is at least 1 degree, more preferably at least 2 degrees, yet more preferably at least 3 degrees, and yet more preferably at least 5 degrees. In some embodiments, the average expansion angle is about 5 degrees. The length of the expansion section will then be determined by the expansion angle and the size of the expanded diameter that the taper must reach. However, the expansion section extends at least 0.1 D relative to the longitudinal axis.

Another way to express the rate at which the expansion section expands is as a rate of radial expansion of the internal radius of the collar from the constriction end to the expanded diameter of the collar. In some embodiments, the maximum rate of radial expansion is less than 0.315 mm/mm, preferably from 0.0087 mm/mm to 0.105 mm/mm, more preferably from 0.052 mm/mm to 0.087 mm/mm. In some embodiments, the maximum rate of radial expansion is less than 0.27 mm/mm, preferably less than 0.176 mm/mm.

The expansion section provides a section where the expansion of the hydrogen separation membrane can preferably gradually expand to the maximum expanded diameter over a length of the hydrogen separation membrane (relative to the longitudinal axis). Rapid expansion may still result in stress raising areas within the hydrogen separation membrane. Accordingly, the expansion section preferably extends at least 0.2 C relative to the longitudinal axis. A greater length can be advantageous. Thus, in embodiments, the expansion section extends at least 0.3 C, preferably at least 0.4 C, more preferably at least 0.5 C relative to the longitudinal axis.

It should also be appreciated that the transition section is located at the transition from the constriction diameter to the angled or curved section (i.e. tapered or curved surface) of the expansion section. In embodiments, the average expansion angle includes the curve provided by the transition section (and comprising transition radius).

As detailed above, when hydrogen is introduced into the hydrogen separation membrane, the hydrogenated hydrogen separation membrane (tube) will expand within the constriction collar, and that expansion will be constrained to the limits of the inner surface of the constriction collar. In the constriction section, the outer surface of the hydrogen separation membrane will engage against the inner wall of that section. Similarly, the outer surface of the hydrogen separation membrane will engage against the inner wall of the expansion section until the point that the natural hydrogen expanded diameter of the hydrogen separation membrane is reached. At the transition section, the outer surface of the hydrogenated hydrogen separation membrane will have a complementary shape/curve around from the constriction diameter to the angled or curved section (i.e. tapered or curved surface) of the expansion section. Here the membrane expands from the constriction diameter to the angled or curved section of the expansion section of the collar following the shape of the transition section. The transition section therefore provides a curved surface that is configured to prevent a stress concentration point being formed when the inner surface of the constriction collar transitions from the constriction diameter to the angled or curved section (i.e. tapered or curved surface) of the expansion section. The curved surface of the transition section preferably has a curve radius of at least 0.1 C. In embodiments, the transition radius comprises from 0.1 C to 10 C, preferably from 0.5 C to 5 C, more preferably from 1 C to 5 C. In some embodiments, the transition radius comprises from 0.5 C to 10 C, more preferably from 1 C to 10 C, more preferably from 2 C to 10 C.

The constriction collar is designed to extend from, and preferably over the connection interface of the hydrogen separation membrane. In embodiments, the constriction section of the constriction collar is configured to extend over the connection interface. In embodiments, the constriction collar can also be configured to extend over the connection interface, and over at least a portion of the connector.

In embodiments, the constriction collar includes a collar fastening section configured to fasten onto a section of the connector. The constriction collar is preferably configured to extend over the connection interface to the constriction collar fastening section. Typically, the constriction collar extends from the constriction end over the connection interface to the constriction collar fastening section. The collar fastening section is configured to fasten onto a section of the connector, and includes a fastening formation configured to interconnect the constriction collar to a cooperative fastening formation of the connector. It should be appreciated that the cooperative fastening formation may comprise a thread, interengageable rib and groove, rib and slot configurations, quick lock configurations or other suitable interengaging fastening configurations. In some embodiments, the fastening formation comprises a threaded connection which is configured to cooperatively fasten onto a thread located on the connector.

In embodiments, the constriction collar further comprises an end cap configured to form an end seal around the connector. The end cap preferably comprises a sealed cap into which the connector is fastened which fluidly seals one end of the hydrogen separation membrane. In some embodiments, the end cap extends from, preferably over, the connection interface and around an end of the connector that is distal to the connection interface. Typically, the end cap extends from the constriction section over the connection interface and around an end of the connector that is distal to the connection interface. The end cap preferably includes a fastening formation configured to interconnect the constriction collar to a cooperative fastening formation of the connector. It should be appreciated that the cooperative fastening formation comprises a thread, interengageable rib and groove, rib and slot configurations, quick lock configurations or other suitable interengaging fastening configurations. In some embodiments, the fastening formation comprises a threaded connection which is configured to cooperatively fasten onto a thread located on the connector.

In embodiments, the connector includes a tubular extension extending longitudinally away from the connection interface relative to the longitudinal axis. Here, the constriction collar includes a sealing section that is configured to extend over the connector, preferably over the tubular extension thereof, to a distal fastening end. Typically, the sealing section extends from the constriction section over the connection interface and to a distal fastening end. The constriction collar in this embodiment further includes a compression fitting configured to fasten to the distal fastening end of the sealing section and at least one ferrule configured to seal around a section of the connector, preferably a section of the tubular extension thereof, when the compression fitting is fastened onto the distal fastening end of the sealing section. The ferrule comprises a sealing member which is compressed by the compression fitting to create a fluid seal between the compression fitting and a portion of the tubular extension. The ferrule can have any suitable configuration and can be made from any suitable material. In some embodiments, the at least one ferrule comprises a graphite ferrule. Similarly, the compression fitting can have any suitable configuration. In embodiments, the compression fitting comprises a sealing nut configured to be threadedly fastened to the distal fastening end of the sealing section. That sealing nut may comprise a compression type fitting or connection such as a Hy-Lok style compression fitting, or a Swagelok type fitting which seals on the distal fastening end of the sealing section. As with the previous embodiments, the sealing section may also include a fastening formation configured to interconnect the constriction collar to a cooperative fastening formation of the connector. Again, it should be appreciated that the cooperative fastening formation comprises a thread, interengageable rib and groove, rib and slot configurations, quick lock configurations or other suitable interengaging fastening configurations. In some embodiments, the fastening formation comprises a threaded connection which is configured to cooperatively fasten onto a thread located on the connector.

The constriction collar can have any suitable overall shape and configuration. In embodiments, the constriction collar comprises a tubular, preferably substantially cylindrical configuration. Similarly, the constriction collar can be formed from any suitable material. In embodiments, the constriction collar is comprised of at least one of: aluminium, an aluminium alloy, steel, stainless steel, nickel-chromium-iron alloy, brass, or a combination thereof.

A sixth aspect of the present invention provides a hydrogen separation membrane constriction collar when used over a joint between a hydrogen separation membrane and a metallic connector, the constriction collar being configured to extend from a connection interface between the hydrogen separation membrane and the connector and over the hydrogen separation membrane, the constriction collar having a longitudinal axis and comprising:
an expansion section configured to axially extend over the hydrogen separation membrane relative to the longitudinal axis from a constriction end to an expanded diameter, the constriction end being configured to extend around the hydrogen separation membrane at or proximate to the connection interface relative to the longitudinal axis and having an inner surface defining a constriction diameter (C) that is configured to extend around the outer surface of the hydrogen separation membrane
wherein the expansion section includes a transition section that extends from the constriction end and comprises a curved surface having a transition radius of at least 0.1 C,
and wherein the expansion section comprises an angled or curved section that extends from the transition section in which the diameter of the constriction collar expands from the constriction diameter to the expanded diameter comprising at least 1.01 C.

It is to be understood that the constriction collar in the first and fifth aspects of the present invention share a number of similar features to the constriction collar of this sixth aspect of the present invention and that the above disclosure of the first and fifth aspects of the present invention equally applies to like features of the constriction collar of this sixth aspect of the present invention.

A seventh aspect of the present invention provides a method of joining and sealing a hydrogen separation membrane to a metallic connector comprising:
mounting an end section of a metallic hydrogen separation membrane on or against a connector formation of a connector, the connector being formed of a different metal to the hydrogen separation membrane, the hydrogen separation membrane having an outer diameter (D) about the longitudinal axis, the hydrogen separation membrane and the connector formation contacting at a connection interface in which an end face of the hydrogen separation membrane is proximate to, substantially abuts or overlaps an adjoining face of the connector formation; joining the hydrogen separation membrane to the connector formation to join and seal the hydrogen separation membrane to the connector over the connection interface; and
locating a constriction collar according to the fifth or sixth aspect of the present invention over the hydrogen separation membrane to extend from at least the connection interface and extend axially over the hydrogen separation membrane relative to the longitudinal axis.

It should be appreciated that this seventh aspect of the present invention can include any one or combination of the features described above in relation to constriction collar comprising the fifth and sixth aspect of the present invention. It should also be appreciated that this seventh aspect of the present invention can include any one or combination of the features described above in relation to the method comprising the second aspect of the present invention. Furthermore, in embodiments, the method according to this seventh aspect of the present invention can be used to form the joining and sealing arrangement according to first aspect of the present invention.

An eighth aspect of the present invention provides a joining and sealing arrangement for joining and sealing together a hydrogen separation membrane to a metallic connector comprising:
a metallic hydrogen separation membrane mounted on or against a connector formation of the connector about a longitudinal axis, the connector being formed of a different metal to the hydrogen separation membrane, the hydrogen separation membrane having an outer diameter (D) about the longitudinal axis, the hydrogen separation membrane and the connector formation contacting at a connection interface in which an end face of the hydrogen separation membrane is proximate to, substantially abuts or overlaps an adjoining face of the connector formation;
a connection that connects the hydrogen separation membrane and the connector formation about the connection interface; and
the constriction collar according to the fifth or sixth aspect of the present invention configured to extend from at least the connection interface and extend axially over the hydrogen separation membrane relative to the longitudinal axis.

It should be appreciated that this eighth aspect of the present invention can include any one or combination of the features described above in relation to constriction collar comprising the fifth or sixth aspect of the present invention. It should also be appreciated that this eighth aspect of the present invention can include any one or combination of the features described above in relation to the joining and sealing arrangement according to first aspect of the present invention.

### BRIEF DESCRIPTION OF THE DRAWINGS

The present invention will now be described with reference to the Figures of the accompanying drawings, which illustrate particular preferred embodiments of the present invention, wherein:

FIG. 1 illustrates a cross-sectional view of a first embodiment of the joining and sealing arrangement of the present invention.

FIG. 2 provides a cross-sectional view of the constriction collar of the embodiment illustrated in FIG. 1.

FIG. 2A provides a cross-sectional view of an alternate embodiment of the constriction collar of the embodiment illustrated in FIG. 1 that includes a curved expansion section.

FIG. 3 provides a perspective view of the constriction collar of the embodiment illustrated in FIGS. 1 and 2.

FIG. 3A provides a cross-sectional view of a second embodiment of the joining and sealing arrangement of the present invention.

FIG. 4 illustrates a cross-sectional view of a third embodiment of the joining and sealing arrangement of the present invention.

FIG. 5 provides a cross-sectional view of the constriction collar of the embodiment illustrated in FIG. 4.

FIG. 6 provides a perspective view of the constriction collar of the embodiment illustrated in FIGS. 4 and 5.

FIG. 7 illustrates a cross-sectional view of a fourth embodiment of the joining and sealing arrangement of the present invention.

FIG. 8 provides a perspective view of the constriction collar of the embodiment illustrated in FIG. 7.

FIG. 9 illustrates the steps involved in forming a planar connection surface on the end of a vanadium-based tube for use in a joining and sealing arrangement of the present invention.

FIG. 10 provides an optical microscopy images of the cross-section of one welded connection between the end section of the vanadium-based membrane and a connector formation of a connector.

FIG. 11 provides a radial displacement model illustrating how much the vanadium-based membrane displaces within the constriction collar of the joining and sealing arrangement illustrated in FIGS. 1, 2, 2A and 3 when the vanadium-based membrane is hydrogenated.

FIG. 12 provides the results of an axial and hoop stress model on the welded connection of the joining and sealing arrangement illustrated in FIGS. 1 to 3 when the vanadium-based membrane is hydrogenated showing (A) axial stress of the membrane; (B) hoop stress of the weld; and (C) axial stress of the weld.

FIG. 13 is a plot of (A) axial stress on the weld outer surface vs distance from the welded connection; and (B) hoop stress on the weld outer surface vs distance from the welded connection, for the joining and sealing arrangement illustrated in FIGS. 1, 2, 2A and 3 when the vanadium-based membrane is hydrogenated.

FIG. 14 is a plot of (A) axial stress of inner surface of the vanadium membrane at the connection interface vs distance from the welded connection; and (B) hoop stress of inner surface of the vanadium membrane at the connection interface vs distance from the welded connection, for the joining and sealing arrangement illustrated in FIGS. 1, 2, 2A and 3 when the vanadium-based membrane is hydrogenated.

FIG. 15 provides the results of stress modelling for the longitudinal bending stress at the outer surface of the membrane at average expansion angles of 1, 3, 5, 6, 10, and 17.5 degrees modelled from the end of the transition section in the expansion section.

FIG. 16 provides the results of stress modelling for the longitudinal bending stress at the outer surface of the membrane at average expansion angles of 1, 3, 5, 6, 10 and 17.5 degrees modelled from the start of the transition section.

FIG. 17 provides a plot of the rate of radial expansion (mm/mm) versus distance from the start of the transition section radius (mm) illustrating the different lengths of transition section required for a 5 mm radius transition section for different maximum rates of expansion of the angled or curved section.

### DETAILED DESCRIPTION

The present invention relates to an arrangement for joining and sealing a metallic hydrogen separation membrane to a connector formed from a different metal, for example stainless steel, which includes a connection between the hydrogen separation membrane and the connector.

As explained above, the present invention relates to metallic membranes that can be used produce hydrogen of high permeability and recovery in separating H₂/CO₂ or other H₂ containing gas mixtures. In embodiments, the hydrogen separation membrane comprises a group 5 (group V) based metal or metal alloy such as a vanadium, tantalum or niobium metal or metal alloy. For the purposes for the rest of the specification hydrogen separation membranes formed from vanadium or a vanadium alloy are exemplified. However, it should be appreciated that the present invention can be more generally applied to other metallic hydrogen separation membranes, and in particular other group 5 metals or metal alloys.

As explained in the background, vanadium-based hydrogen-selective membrane tubes can have a linear (dimensional) expansion in the order of up to +5% and can volumetrically expand in the order of up to +15% when hydrogenated at conventional operating temperatures/pressures, compared to ambient conditions without hydrogen. Other metallic hydrogen-selective membrane tubes such as those formed from group 5 metals and alloys thereof have similar linear and volumetric expansion when hydrogenated. This expansion can place significant strain and stress on a welded connection between a vanadium-based membrane and connector which can be significant enough to affect the integrity of the seal and join about the sealed welded connection. The Inventors have found that a constriction collar can be advantageously used to mechanically limit the hydrogenated expansion of the vanadium-based membrane at and proximate to the welded connection. When hydrogen is introduced into the vanadium-based membrane, the hydrogenated vanadium-based membrane (tube) will expand within the constriction collar, and that expansion will be constrained to the limits of the inner surface of the constriction collar.

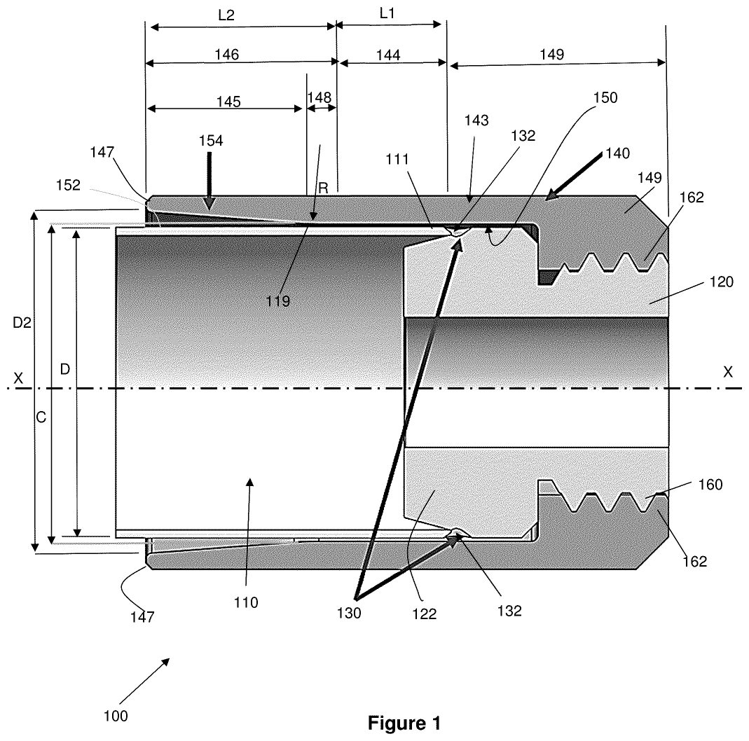

FIG. 1 illustrates a first embodiment of the joining and sealing arrangement 100 of the present invention. The arrangement 100 includes: (1) a vanadium-based membrane 110 preferably comprising a vanadium or vanadium alloy tube suitable for use as a hydrogen selective membrane, for example as taught in U.S. Pat. No. 10,590,516 the contents of which should be understood to be incorporated into this specification by this reference.

The vanadium-based membrane 110 has an outer diameter (D) about the longitudinal axis X-X. As previously noted, that outer diameter D is the outer diameter of the vanadium-based membrane when the vanadium-based membrane 110 is in an un-hydrogenated state (i.e. not in a hydrogenated expanded state). The vanadium-based membrane 110 preferably comprises a thin-walled tube having an outer diameter of between 2 to 25 mm, and a wall thickness of from 0.1 to 1 mm. However, it should be appreciated that other configurations could equally be used as discussed above. Equally it should be appreciated that other metallic membranes could be used, for example other group 5 metals such as tantalum or niobium metal or metal alloy.
(2) a connector 120 comprising a metallic fluid connection fitting (preferably a metallic gas connection fitting) formed from a different metal or metal alloy to the vanadium-based membrane 110, typically one of steel, stainless steel, nickel-chromium-iron alloy, brass, Inconel, incoloy or a combination thereof. The connector 120 includes a connector formation 122 configured to receive an end section 111 of the vanadium-based membrane 110 thereon. In the illustrated embodiment the connector formation 122 comprises a sloped section in the form of a frustoconical shaped section. However, it should be appreciated that other configurations are also possible.
(3) a welded connection 130 over a connection interface 132 between the end section 111 of the vanadium-based membrane 110 and the connector formation 122 where the end section 111 of the vanadium-based membrane 110 substantially abuts or overlaps an adjoining face of the connector formation 122. The welded connection 130 comprises a continuous weld which extends circumferentially around and over the connection interface 132. The welded connection 130 can be formed using any suitable welding technique for example a laser welded connection, or an arc welded connection such as TIG, or electron beam welding. As indicated in more detail below, it should be appreciated that other types of connections such as threaded, or O-ring sealed connections could equally be used.
(4) a constriction collar 140 configured to extend from at least the connection interface 132 and welded connection 130 and extend axially over the vanadium-based membrane 110 relative to the longitudinal axis X-X. In the illustrated embodiment, the constriction collar extends over the connection interface 132 and welded connection 130 and extends axially over the vanadium-based membrane 110 and at least part of the connector 120 relative to the longitudinal axis X-X. The illustrated constriction collar 140 comprises a substantially cylindrically shaped tube. However, it should be appreciated that the constriction collar can have any suitable overall shape and configuration. The constriction collar is typically comprised of at least one of: steel, stainless steel, nickel-chromium-iron alloy, brass, or a combination thereof.

As illustrated in FIGS. 1, 2 and 3 the constriction collar 140 has the following interconnected sections: (1) a constriction section 144; (2) an expansion section 146; and (3) a transition section 148 at the start of the expansion section 146. The illustrated constriction collar 140 also includes a collar fastening section 149. Each of these sections will now be discussed in more detail:

The constriction section 144 is configured to move the expansion zone of the vanadium-based membrane 110 away from the welded connection 130 thereby reducing the strain on the welded connection 130 and allowing the seal of the welded connection 130 to remain intact during changes in expansion and contraction experienced during changes in membrane 110 hydrogenation. It does this by providing a mechanical constraint on the hydrogen-metal (H/M) expansion within this section. As shown best in FIG. 1, the constriction section 144 is configured to axially extend over the vanadium-based membrane 110 from the connection interface 132 (and welded connection 130 thereon) to a transition section 148, which is located at the start of the expansion section 146. Here, the inner surface 150 of the constriction collar 140 abuts, and more preferably is spaced apart (for example is substantially parallel spaced apart) from the outer surface 152 of the vanadium-based membrane 110. The inner surface of the constriction section 144 defines a constriction diameter C which is from 0.95× to 1.05× the outer diameter D of the vanadium-based membrane 110. In embodiments, such as the illustrated embodiment, the constriction diameter C is larger than D (C>D). For example, C can be 1.01 D to 1.05 D, for example 0.05 mm larger than the outer diameter D of the vanadium-based membrane 110. Here the constriction diameter C of the inner surface 150 of the constriction section 144 is spaced apart from outer surface 152 of the vanadium-base membrane 110 when the vanadium-based membrane is in an un-hydrogenated state. This spacing provides a small gap enabling the vanadium-based membrane and connector to be fitted within the constriction collar. The constriction diameter is also preferably no more than 0.12 mm larger than the outer diameter D of the vanadium-based membrane 110 to substantially limit movement of the vanadium-based membrane 110 about the welded connection 130 between the vanadium-based membrane 110 and the connector 120 during changes in expansion and contraction experienced during changes in membrane hydrogenation. It should be appreciated that the constriction diameter C in the constriction section could be substantially the same as D in some embodiments, leading to an interference fit between the overlapping parts of the constriction section 144 of constriction collar 140 and the vanadium-based membrane 110.

The inner surface 150 of the constriction collar 140 is also preferably spaced apart, typically substantially parallel spaced apart from the outer surface 152 of the connector 120 on the other side of the welded connection, with the collar also extending over the welded connection 130 and connection interface 132 therein. This constriction part 143 of the constriction collar 140 can therefore mechanically constrain any expansion of the welded connection 130 during hydrogenation expansion and cycling.

It should be understood that whilst the dimensions discussed below are stated in terms of the outer diameter D of the vanadium-based membrane 110, these dimensions could equally be expressed in terms of the constriction diameter C. As noted above, depending on the embodiment, the inner surface of the constriction section defining a constriction diameter C which is from 0.95× to 1.05× the outer diameter D of the vanadium-based membrane 110.

The length L1 of the constriction section 144 is selected to provide sufficient spacing of the connection interface 132 (and welded connection 130 thereon) from the expansion section 146. For the embodiment illustrated in FIG. 1, the constriction section 144 extends over the vanadium-based membrane 110 from the connection interface 132 to the transition section 148 for at least 0.25 D, and preferably from 0.25 D to 2D.

The expansion section 146 controls the expansion of the hydrogenated vanadium-based membrane 110 using a slope or curve to provide a progressive expansion of the vanadium-based membrane 110 to its natural diameter as the vanadium-based membrane 110 extends away from the welded connection along the longitudinal axis X-X. The diameter of the constriction collar 100 expands from the constriction diameter C to an expanded diameter D2 in the expansion section 146. This progressive expansion is controlled by the configuration of the expansion section 146, which in the illustrated embodiment has a sloped or tapered internal diameter 154 in FIGS. 1 to 3 which progressively increases in diameter from the constriction diameter C to the expanded diameter D2 at the distal end 147 of the expansion section 146. In the illustrated embodiment, the change from the constriction diameter C to the expanded diameter D2 comprises the transition section 148 (described in more detail below) and an angled section 145 comprising a sloped surface having an expansion angle α relative to the longitudinal axis comprising a non-zero angle of less than 17.5 degrees (i.e. an angle of greater than zero to 17.5 degrees, for example from 0.5 to 17.5 degrees, preferably from 0.5 to 6 degrees. In the illustrated embodiments the sloped surface is around 5 degrees. The expanded diameter D2 is selected to be greater than the maximum diameter of the vanadium-based membrane once hydrogenated. As explained previously, vanadium-based hydrogen-selective membrane tubes can have a linear expansion in one dimension/axis (such as diameter) of up to 5% linearly when hydrogenated at conventional operating temperatures/pressures, compared to ambient conditions without hydrogen. The expanded diameter D2 is therefore at least 1.01 D, and preferably at least 1.02 D. However, where expansion is intended to be greater than maximum linear expansion, the expanded diameter D2 can be at least 1.05 D. The length of the expansion section L2 will then be determined by the expansion angle α and the size of the expanded diameter D2 that the slope/taper must reach.

As noted previously, it should be appreciated that the expanded diameter D2 (FIG. 1) will also be greater than the constriction diameter C of the constriction section 144 of the constriction collar 140. Similarly, the maximum diameter of the hydrogen separation membrane 110 once hydrogenated, diameter D_{MH} (not illustrated), is greater than the constriction diameter C of the constriction section 144 of the constriction collar 140, and also the outer diameter D of the metallic hydrogen separation membrane 110 when the metallic hydrogen separation membrane 110 is in an unhydrogenated state—as can be appreciated by the very nature of the hydrogenation process.

The transition section 148 is located at the start of the expansion section 146, and forms a curved transition surface between the constriction section 144 and the angled section 145 of the expansion section 146. As illustrated, the transition section 148 comprises a curved surface 119 having a radius R of at least 0.1 D, and typically anywhere from 0.1 D to 10 D. The transition section 148 therefore provides a curved surface that is configured to prevent a stress concentration point being formed when the inner surface of the constriction collar 140 transitions from the constriction diameter C to the tapered surface of the expansion section. In this respect, when hydrogen is introduced into the vanadium-based membrane, the hydrogenated vanadium-based membrane (tube) will expand within the constriction collar 140, and that expansion will be constrained to the limits of the inner surface of the constriction collar 140. In the constriction section 144, the outer surface 152 of the vanadium-based membrane 110 will engage against the inner surface 150 of that section. Similarly, the outer surface 152 of the vanadium-based membrane 110 will engage against the inner surface 150 of the expansion section 146 until the point that the natural hydrogen expanded diameter of the vanadium-based membrane 110 is reached. At the transition section 148, the outer surface 152 of the hydrogenated vanadium-based membrane 110 will follow the shape/curve of the transition section 148 to expand from the constriction diameter C to the tapered surface 154 of the expansion section 146.

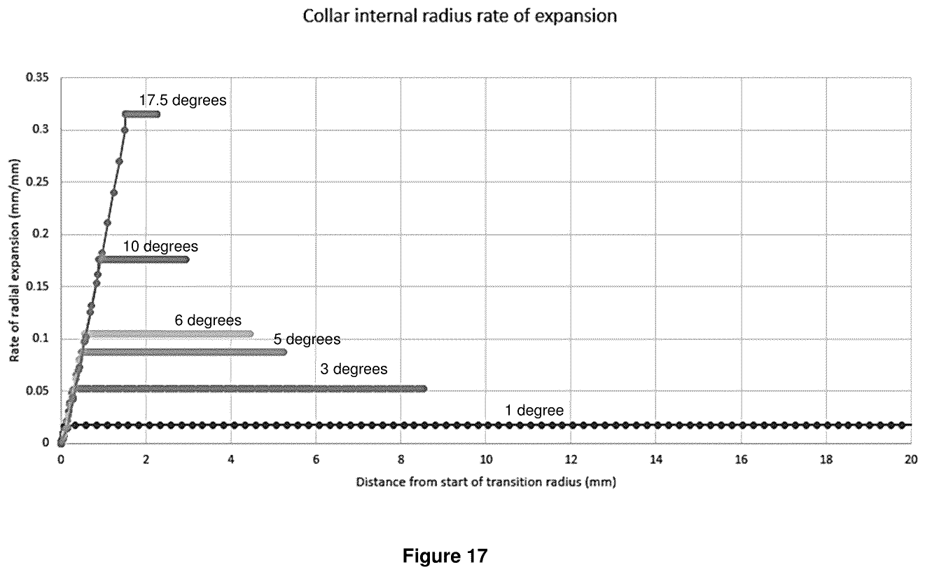

It should be appreciated that the length of the transition section 148 is dependent on the transition radius R, and the average slope/angle of the angled section 145 of the expansion section 146. This length depends on the intersecting tangent between the curve of the transition radius, and the slope of the angled section 145. For the same transition radius R, the length of the transition section 148 is greater for greater expansion angles α, as explained below in relation to FIG. 17.

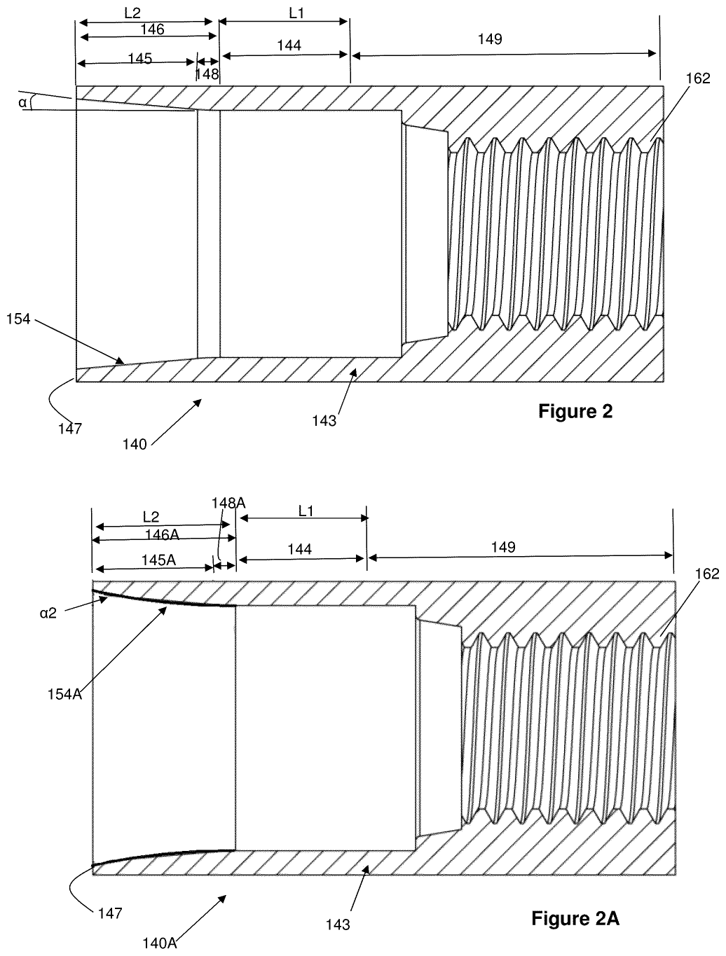

The transition section 148 is located at the end of the constriction section 144 and at the start of the expansion section 146 and transitions that the surface of the constriction section 144 to the tapered surface 154 of the angled section 145 of the expansion section 146. In one embodiment, the expansion angle α as shown in FIG. 2 includes the curve provided by the transition section 148 (and comprising transition radius R). In alternate embodiments, the tapered surface 154 may not have a linear slope, but may comprise a curved surface, or include multiple curves or slopes. For example, FIG. 2A illustrates an embodiment of the constriction collar 140A which the angled section 145A (here a curved section) and the transition section 148A comprise a continuous curved surface 154A. In this embodiment, the transition section 148A and the angled (curved) section 145A of the expansion section 146A follow the same or similar curve and can share a common radius. Nevertheless, it should be appreciated that in other embodiments, the transition section 148A could lie on different curves to the angled (curved) section 145 following the transition section 148A. It should also be appreciated that like features in FIG. 2A to those illustrated and described in relation to FIGS. 1 and 2 have been provided the same reference numerals, and the description of those features equally apply to this embodiment. In embodiments where at least the expansion section lies on at least one curve, the expansion angle α (shown as α2 in FIG. 2A) comprises an average expansion angle of the curve, and will typically be a non-zero angle of less than 17.5 degrees, for example between 0.5 and 17.5 degrees, preferably from 0.5 to 6 degrees. Nevertheless, the expansion section 146A and that tapered/curved/sloped surface 154A provides the same function as explained above, as it will still provide a progressively larger diameter on average from the constriction diameter C to the expanded diameter D2 at the distal end 147 of the expansion section 146. In these embodiments, the average expansion angle may also include the curved section provided by the transition section 148.

As shown in FIG. 1, the constriction collar 140 also includes a collar fastening section 149 that extends over the connection interface 132 configured to fasten onto a section of the connector 120. Here the connector 120 includes a fastening formation, which in the illustrated embodiment comprises a thread 160. However, a variety of other interengaging fastening configurations could be used. The fastening section 149 comprises a cooperating fastening formation, again a thread 162 configured to interconnect the constriction collar fastening section 149 to the connector 120.

As noted above, the vanadium-based membrane 110 comprises a vanadium or vanadium alloy tube suitable for use as a hydrogen selective membrane, for example as taught in U.S. Pat. No. 10,590,516. As taught in that specification the vanadium-based membrane can be formed from vanadium or a vanadium alloy. Typically, the particular vanadium metal or alloy is selected based on its suitability for use in a membrane separation device. In some embodiments, the vanadium-based membrane comprises a vanadium alloy comprising: vanadium; aluminium having a content of greater than 0 to 10 at %; and Ta content of less than 0.01 at %, having a ductility of greater than 10% elongation, preferably greater than 11% elongation. The vanadium alloy can further comprise a grain refining element selected from Ti, Cr, Fe, Ni or B having a content of greater than 0 to 5 at %, preferably between 0.2 and 4.5 at %. In some embodiments, the grain refining element has a content from 0.1 to 2 at %, preferably from 0.1 to 2 at %, and more preferably from 0.1 to 1 at %. In some embodiments, the vanadium-based membrane is coated in a Pd based coating or a Pd—Au based coating. Once again, it should be appreciated that whilst the illustrated the hydrogen separation membrane comprises a vanadium-based membrane 110, that membrane 110 could equally be formed from other metallic membrane materials such as a group 5 based metal or metal alloy, for example tantalum or niobium.

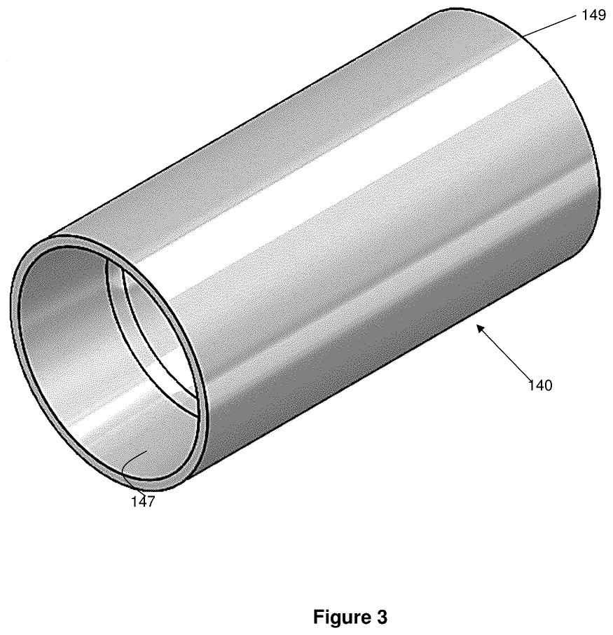

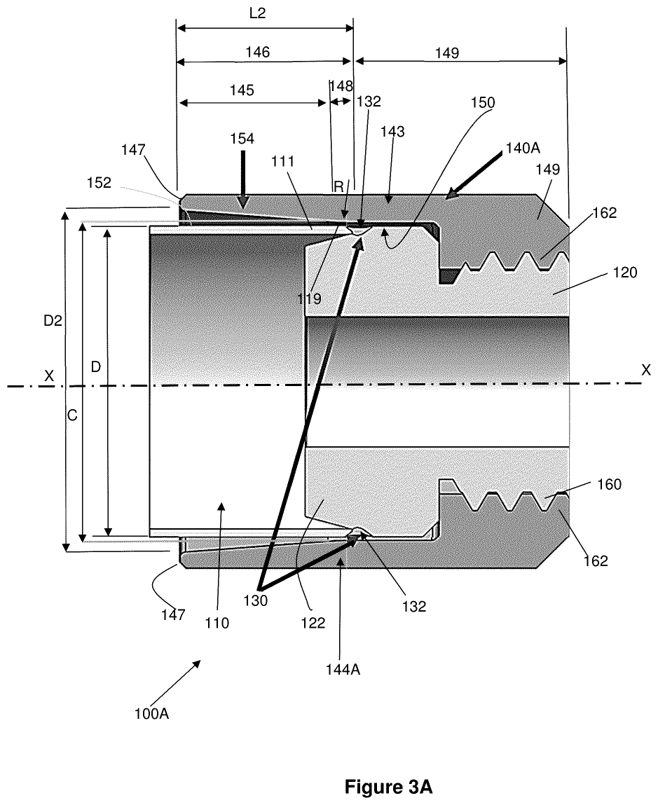

FIG. 3A provides an alternate (second) embodiment of the joining and sealing arrangement 100 of the present invention. The arrangement 100A includes many of the same features as the first embodiment illustrated in FIGS. 1 to 3, with like features having the same reference numerals as used in FIGS. 1 to 3. It should be understood that the description above for the first embodiment for those features equally applies to those like features illustrated in FIG. 3A. In this embodiment, the constriction collar 140A is configured without the constriction section 144 (FIG. 1) which is present in the first embodiment. Like the first embodiment, the constriction collar 140A is configured to extend from a constriction end 144A of the expansion section 146 from at least the connection interface 132 and welded connection 130 axially over the vanadium-based membrane 110 relative to the longitudinal axis X-X. The constriction collar 140A also extends over the connection interface 132 and welded connection 130 and extends axially over the vanadium-based membrane 110 and at least part of the connector 120 relative to the longitudinal axis X-X. This second embodiment of the constriction collar 140A has the following interconnected sections: (1) An expansion section 146; (2) A transition section 148; and (3) A collar fastening section 149. Each of these sections will now be discussed in more detail:

Like the first embodiment, the expansion section 146 controls the expansion of the hydrogenated vanadium-based membrane 110 using a slope or curve to provide a progressive expansion of the vanadium-based membrane 110 to its natural diameter as the vanadium-based membrane 110 extends away from the welded connection along the longitudinal axis X-X. Again, the expansion section comprises the transition section 148 and angled section 145. The diameter of the constriction collar 100 expands from a constriction diameter C at a constriction end 144A of the expansion section 146 to an expanded diameter D2 at the other end of the expansion section 146. Like the first embodiment, the angled section 145 of the expansion section 146 comprises a sloped surface having an expansion angle α relative to the longitudinal axis comprising a non-zero angle of less than 17.5 degrees (i.e. an angle of greater than zero to 17.5 degrees), for example an angle from 0.5 to 17.5 degrees, preferably from 0.5 to 6 degrees. Again, the expanded diameter D2 is at least 1.01 D, and preferably at least 1.02 D. However, where expansion is intended to be greater than maximum linear expansion, the expanded diameter D2 can be at least 1.05 D. The length L2 of the expansion section 146 will then be determined by the expansion angle α and the size of the expanded diameter D2 that the taper must reach.

The constriction end 144A is located at the start of the expansion section 146 proximate connection interface 132, and is the region of the constriction collar 140A in which the inner surface 150 of the constriction collar 140 abuts or is spaced apart from the outer surface 152 of the vanadium-based membrane 110. The inner surface of the constriction end 144A defines a constriction diameter C which is from 0.95× to 1.05× the outer diameter D of the vanadium-based membrane 110.

In this embodiment, the transition section 148 extends from the constriction end/portion 144A and into the expansion section 146 and comprises a curved surface 119 having a radius R of at least 0.1 D, and typically anywhere from 0.1 D to 10 D. The curved surface provides a gradual increase in rate of expansion from the constriction diameter, until the rate of expansion reaches a maximum at the angled section 145. The gradual increase in expansion provided by the curved surface 119 reduces strain at the welded connection 130.

The inner surface 150 of the constriction collar 140 can also be configured to extend over the welded connection 130 and connection interface 132—as shown in the embodiment illustrated in FIG. 3A. This constriction part 143 of the constriction collar 140 can therefore mechanically constrain any expansion of the welded connection 130 during hydrogenation expansion and cycling.

As shown in FIG. 3A, the constriction collar 140 also includes a collar fastening section 149 that extends over the connection interface 132 configured to fasten onto a section of the connector 120. Here the connector 120 includes a fastening formation, which in the illustrated embodiment comprises a thread 160. However, a variety of other interengaging fastening configurations could be used. The fastening section 149 a cooperating fastening formation, again a thread 162 configured to interconnect the constriction collar fastening section 149 to the connector 120.

Whilst FIGS. 1 to 3A illustrate a welded connection 130 over a connection interface 132 between the end section 111 of the vanadium-based membrane 110, it should be appreciated that other types of connections could be used in place of that welded connection 130, with the constriction collar 140 operating in an equivalent manner as described above. For example, that welded connection could alternatively comprise any suitable gas sealing connection between those bodies, for example (but not limited to) welded connections, brazed connections, threaded connections, O-ring sealed connections or the like.

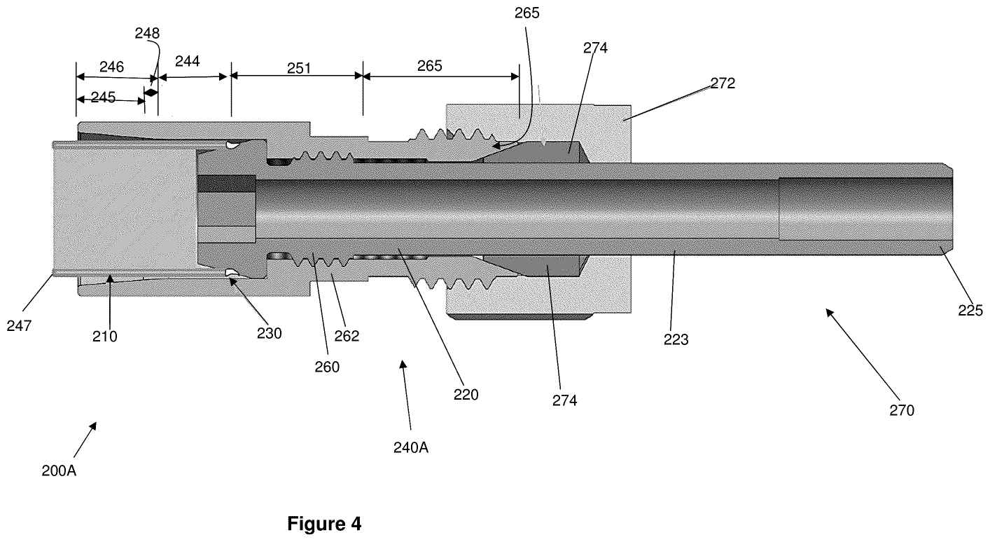

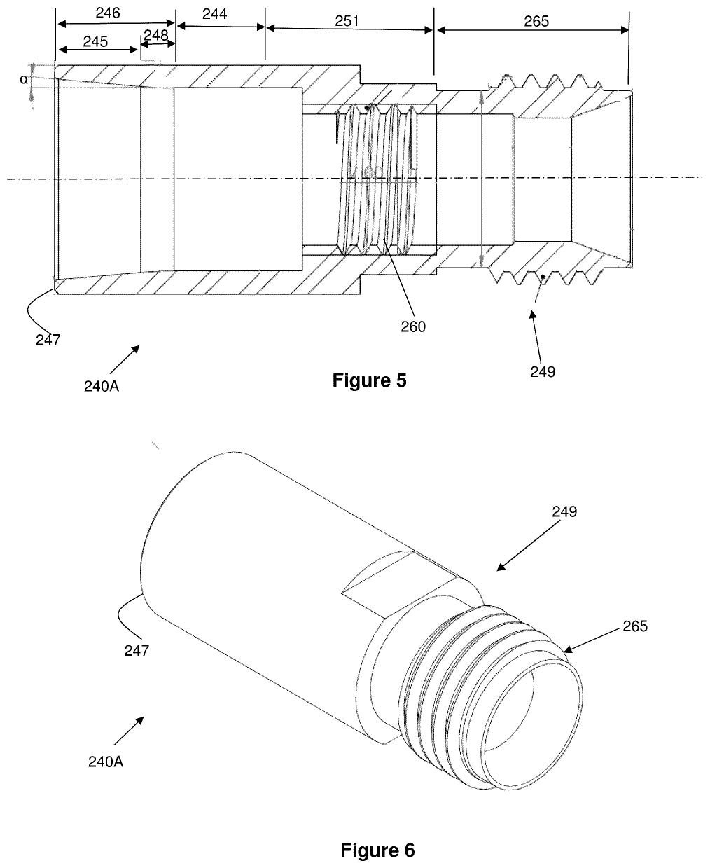

There may still be opportunity for leaks to develop at the welded connection 130, even when using the constriction collar 140 illustrated in FIGS. 1 to 3A, resulting in loss of ability to maintain high purity hydrogen production. FIGS. 4 to 8 teach a third embodiment of the joining and sealing arrangement 200A and 200B of the present invention which has been designed with further sealing features in the event of weld failure and/or defects that may affect the weld upon hydrogenation and the resultant expansion of the vanadium-based membrane 210.

In this embodiment, the constriction collar 240A and 240B can be configured to provide both mechanical constraint and also has a section that provides back-up to seal integrity to reduce dependency of weld only for seal integrity. This assists in isolating the welded connection 230 from variations in external processing conditions. This secondary seal is designed to isolate the welded connection 230 and can provide a back-up layer/buffer of additional sealing, in the event of weld failure during cycling or other operational changes

As shown in FIGS. 4 to 8, the constriction collar 240A and 240B has two different configurations, designed for the particular end of the vanadium-based membrane 210 onto which the constriction collar 240A and 240B is designed to be fitted. Each vanadium-based membrane 210 will therefore include:
1. A flow end connector collar 240A which includes a tubular sealing extension end 270 designed to connect with the flow/flange end of the vanadium-based membrane 210; and
2. A blind plug collar 240B which forms an end cap on the blind end of the vanadium-based membrane 210.

It should be appreciated that both the flow end connector collar 240A and the blind plug collar 240B both include the following same features as the first embodiment. It should be appreciated that like features with the first embodiment have been provided the same reference numerals plus 100 and that the description above for that first embodiment for those features equally applies to those features illustrated in FIGS. 4 to 8. These features are:
(1) a vanadium-based membrane 210 comprising a vanadium or vanadium alloy tube suitable for use as a hydrogen selective membrane. The vanadium-based membrane 210 has an outer diameter (D) about the longitudinal axis X-X.
(2) a connector 220 comprising a metallic fluid connection fitting (preferably a metallic gas connection fitting) formed from a different metal or metal alloy to the vanadium-based membrane 210, typically one of steel, stainless steel, nickel-chromium-iron alloy, brass, Inconel, incoloy or a combination thereof. The connector 220 includes a connector formation 222 configured to receive an end section 111 of the vanadium-based membrane 110 thereon. In the illustrated embodiment the connector formation 222 comprises a sloped section in the form of a frustoconical shaped section. However, it should be appreciated that other configurations are also possible. As explained in more detail below, the exact configuration of the connector 220 for the flow end connector collar 240A and the blind plug collar 240B is tailored to the function of the respective end (flow end or blind end) of the vanadium-based membrane 210.
(3) a welded connection 230 over a connection interface 232 between the end section 211 of the vanadium-based membrane 210 and the connector formation 222 where the end section 211 of the vanadium-based membrane 210 substantially abuts or overlaps an adjoining face of the connector formation 222. The welded connection 230 comprises a continuous weld which extends circumferentially around and over the connection interface 232.
(4) a constriction collar 240A, 240B configured to extend from at least the connection interface 132 and welded connection 130 and extend axially over the vanadium-based membrane 110 relative to the longitudinal axis X-X. The illustrated constriction collar 140 comprises a substantially cylindrical tube. However, it should be appreciated that the constriction collar 240A, 240B can have any suitable overall shape and configuration. The constriction collar 240A, 240B is typically comprised of at least one of: steel, stainless steel, nickel-chromium-iron alloy, brass, or a combination thereof. Each of the flow end connector collar 240A and the blind plug collar 240B embodiments have the interconnected sections: (A) A constriction section 244; (B) An expansion section 246; and (C) A transition section 248 as described above for the first embodiment, the details of which are equally applicable to this second embodiment. The configurational difference with the first embodiment, are in the configuration of the constriction collar fastening section 249.

The flow end connector collar 240A is illustrated in FIGS. 4 to 6. In this embodiment, the connector 220 comprises a flow connection fitting which includes the connection formation 222 at one end as described above, and a tubular extension section 223 extending longitudinally away from the connection interface to a distal end 225. This tubular extension 223 includes a threaded connector 260 proximate the connection formation 222 end designed to threadedly engage with a connection section 251 of a collar fastening section 249 of the flow end connector collar 240A. Here, the constriction collar fastening section 249 extends over the connection interface 232 to the first connection section 251. The fastening section 249 has a cooperating fastening formation, again a thread 262 configured to interconnect the constriction collar fastening section 249 to the connector 220. The constriction collar fastening section 249 also includes a threaded sealing end 265 that is configured to seal and interconnects to a compression fitting 272 (for example compression fitting such as a Hy-Lok style compression fitting, or a Swagelok style connector), and uses ferrules 274, preferably graphite ferrules to seal between the tubular extension 223. The illustrated compression fitting 272 comprises a sealing nut configured to be threadedly fastened to the distal fastening end of the sealing section. However, any suitable compression fitting and cooperative fastening arrangement could be used to fit the compression fitting 272 onto the sealing end 265 of the flow end connector collar 240A. The compression fitting 272 and ferrules 274 are tightened onto the sealing end 265 of the flow end connector collar 240A to create a fluid seal between the compression fitting 272 and ferrule 274 and a portion of the tubular extension 223. The ferrule 274 can have any suitable configuration. Thus, as shown in FIG. 4, the secondary seal around the welded connection 230 comprises:
(1) Upstream of welded connection 230: Sealing of vanadium-based tube 210 to the constriction collar 240A in the constriction section 244 and part of the expansion section 246, when vanadium-based tube 210 expands to be mechanically constrained in those sections 244, 246 when hydrogenated; and
(2) Downstream of welded connection 230: A seal between the compression fitting 272 and ferrule 274 and a portion of the tubular extension 223.

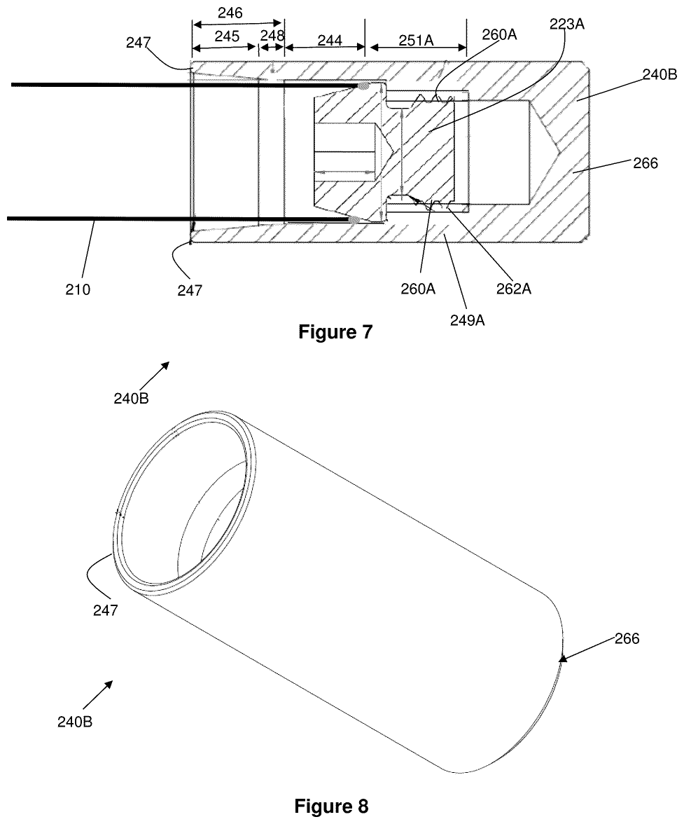

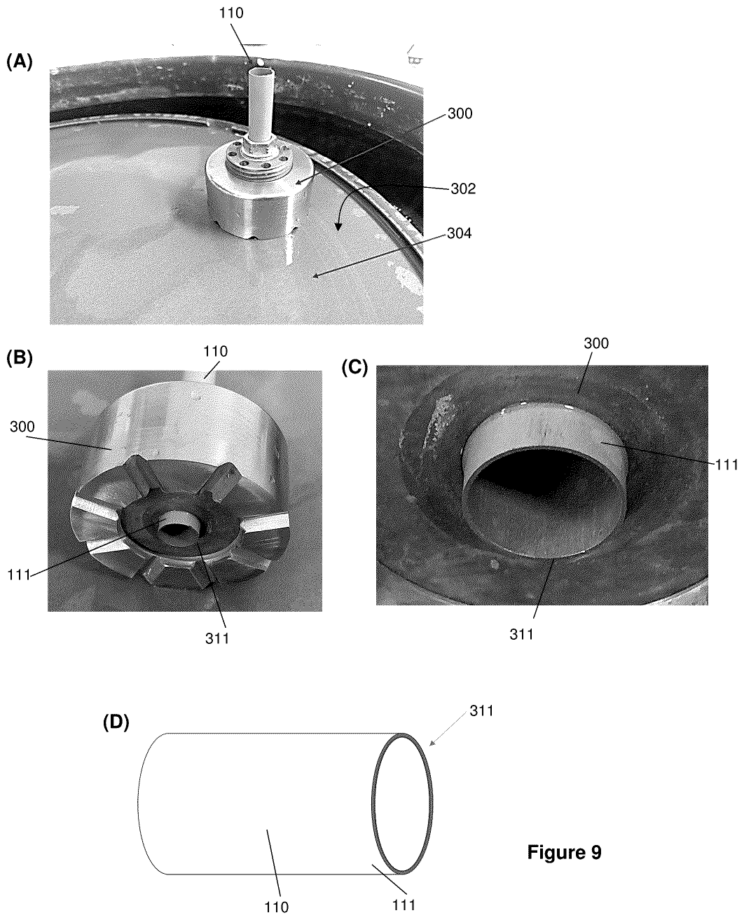

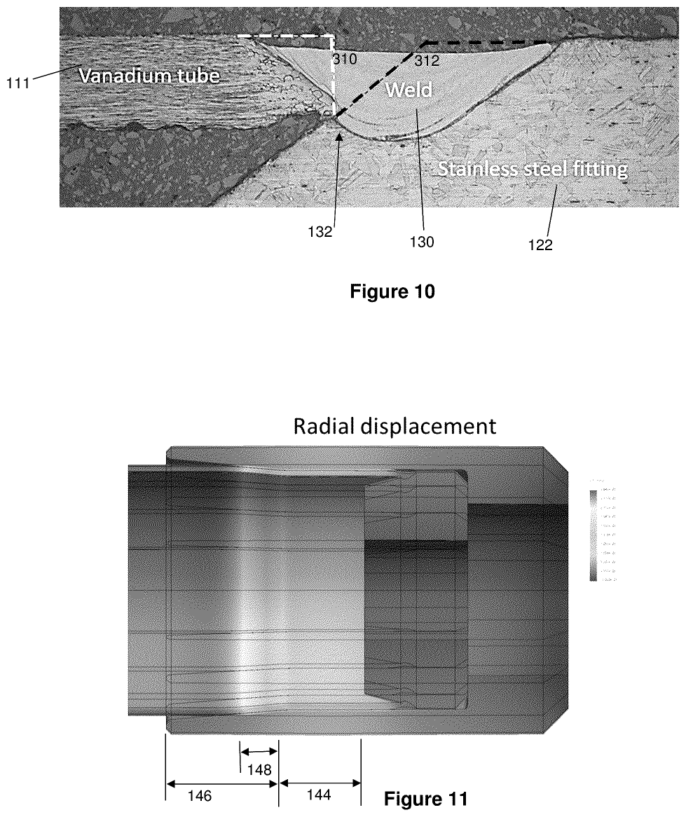

The blind plug collar 240B is illustrated in FIGS. 7 and 8. In this embodiment, the connector 220 comprises a blind plug/end cap fitting which includes the connection formation 222 at one end as described above, and a blind end 223A. This blind end 223A comprises a solid section having a threaded connector 260A designed to threadedly engage with a connection section 251A of a collar fastening section 249A of blind plug collar 240AB. Here, the constriction collar fastening section 249A extends over the connection interface 232 to the first connection section 251A. The fastening section 249A has a cooperating fastening formation, again a thread 262A configured to interconnect the constriction collar fastening section 249A to the connector 220. The constriction collar fastening section 249 also includes a capping end 266 comprising a sealed blind cap attached to and extending from the fastening section 249A configured to fully sealed the blind end 223A of connector 260A within the constriction collar 240B. This configuration ensures that there are no leak points on the cap end side of the vanadium-based membrane 210.

The joining and sealing arrangement 100 illustrated in FIGS. 1 to 3 can be formed using the following methodology:
Step 1: Preparation of Vanadium-based membrane:
   A suitable vanadium-based membrane tube 110 is cut to a suitable length and then each end is squared off to form an end face 311 suitable for use in the end section 111 of the vanadium-based membrane 110 that overlaps an adjoining face of the connector formation 122 of connector 120. This is achieved by clamping the vanadium-based membrane tube 110 in a jig 300 which holds the tube perpendicular to a work surface 302 of a planar grinding disc 304 (or other equivalent grinding arrangement). This jig 300 is then held on a planar grinding disc 304 and the end face 311 ground until that end face 311 of the tube 110 is square.
Step 2: Welding to create the joint/connection:
   The end section 111 of a vanadium-based membrane tube 110 is mounted over and on the ramped surface of connector formation 122 of the connector 120 as shown in FIG. 1 with the vanadium-based membrane tube 110 and the connector formation 120 contacting at a connection interface 132. That connection interface 132 is then welded, for example laser welded, preferably autogenous (no filler wire added) to form welded connection 130. In some embodiments, this weld was completed in two passes. A cross-section of a finished welded connection 130 is illustrated in Figured 10. In this Figure, the dashed line 310 indicates the original shape of the vanadium-based membrane before welding and the dashed line 312 indicates the original shape of the stainless steel connector. Since the surface of the welded connection 130 is either flush or just below the surface of the vanadium-based membrane and stainless steel connector, a close fitting constriction collar 140 can slide over the welded connection.
Step 3: Fitting a constriction collar:
   Finally, a constriction collar 140, as illustrated and described in relation to FIGS. 1 to 3, is fitted over the vanadium-based membrane tube 110 and welded connection 130 to extend from the connection interface and extend axially over the vanadium-based membrane tube 110 relative to the longitudinal axis X-X. As show in FIG. 1, the constriction collar 140 is positioned over the welded connection 130, and is retained on the connector formation 122 using threaded connector 162 in connector section 149.

After hydrogenation, the vanadium-based membrane 110 expands, and the constriction collar 140 constrains the vanadium-based membrane 110 in the constriction section 144 proximate to the welded connection 130. The taper of the expansion section 146 provides a gradual expansion to the final unconstrained dimensions of the vanadium-based membrane 110 when the vanadium-based membrane 110 is hydrogenated.

It should be appreciated that a similar methodology can also be undertaken to form the joining and sealing arrangement 200A and 200B according to the third embodiment of the present invention.

It should also be appreciated that a tubular membrane using the joining and sealing arrangement of the present invention can be incorporated into a tubular catalytic membrane reactor (CMR), for example as taught in U.S. Pat. No. 10,590,516 again the contents of which should be understood to be incorporated into this specification by this reference. As explained in U.S. Pat. No. 10,590,516, a CMR incorporating tubular membranes can be used to selectively extract hydrogen from hydrogen containing gases such as syngas to produce a raffinate (H₂-depleted syngas) and H₂ permeate.

### EXAMPLES

### Example 1—Stress Analysis

The joining and sealing arrangement 100 illustrated in FIGS. 1 to 3 was drawn in SolidWorks (Solidworks Simulation Professional (SSP) software package (Version 2021 Service Pack 5.1 available from Dassault Systems SolidWorks Corporation, Waltham, Massachusetts, USA) and stress analysis was performed taking into account both temperature and vanadium-based membrane expansion from hydrogenation, during typical operating pressures/temperatures.

The axial stress and hoop stress at the outer surface of the connection weld were based on the model outputs only from the SolidWorks described above.

The results of the stress analysis are illustrated in FIG. 11 for radial displacement of the constriction collar 140, connector 120 and the vanadium-based membrane 110 when the vanadium-based membrane 110 expands from hydrogenation. In FIG. 11, radial displacement is colour coded with red indicating greater displacement than blue. As shown in FIG. 11, the constriction collar 140 substantially constrains significant expansion of the vanadium-based membrane 110 in the constriction section 144, with the most radial displacement occurring in the expansion section 146 and transition radius section 148. The modelling results (transition from light blue to orange/red) showing the taper acting as a means to gradually allow the expansion from constrained state in section 144 to full natural expanded dimensions in section 146.

### Example 2—Simulation of Stress in Membrane and Weld Joint Under Hydride Expansion

### BACKGROUND

As the vanadium component of the membrane undergoes the hydriding process (absorption of hydrogen, also known as hydrogenation) a significant expansion of the metal occurs, relative to the amount of hydrogen contained in the lattice. Components of different materials in the membrane mounting/sealing arrangement (stainless steel, vanadium-stainless steel alloy weld) do not experience this expansion as they do not undergo the same scale of hydrogen absorption, if any. Therefore, given the mismatched rates of expansion, significant stress is induced at their interface to the membrane during operation. This stress has been attributed to the past failure of both welds and membranes under various conditions.

### Methodology for Stress Simulations

Several challenges inhibit the opportunity for physical materials testing and measurements during operation, so to gain an understanding of the stresses at critical locations a Finite Element Analysis (FEA) study was performed using the Solidworks Simulation Professional (SSP) software package (Version 2021 Service Pack 5.1 available from Dassault Systems SolidWorks Corporation, Waltham, Massachusetts, USA). It is noted that hydride lattice expansion is not a phenomenon supported natively by SSP, so a custom method of emulating such expansion was required.

Simulation of materials under thermal expansion is a core ability of SSP and enables the modelling of effects expected under hydride expansion, such as:
Isotropic expansion proportional to temperature (hydrogen content)
Internal stress profile dependent on temperature gradient (hydrogen content gradient)
Contact behaviour between materials of differing thermal expansion coefficients (hydride expansion coefficient)

Mechanical properties of metals can change significantly at elevated temperatures, therefore a combined thermal+hydride expansion analysis approach was taken to gain insight into likely failure mechanisms in operating conditions (both temperature and with hydrogen at pressure). A nominal steady-state temperature of 325° C. was chosen and material properties adjusted to reflect the expected reduction in tensile strength.

Experimental data on vanadium hydride properties was obtained from Synchrotron analysis of vanadium hydride using in situ (non-ambient) synchrotron X-ray powder diffraction to i) measure hydrogen-induced lattice expansion, and ii) hydride formation in vanadium-based alloys. Data was obtained for vanadium hydride formation for various temperatures and various hydrogen partial pressures, and used to estimate the unit cell volumes at each condition, and therefore infer hydrogen-induced lattice expansion/volumetric expansion. That experimental data was matched with expected maximum practical level of hydrogen absorption, with H/M or hydrogen to metal ratio of 0.65. It is noted that the ratio of hydrogen to metal atoms (H/M) in a vanadium based membrane can be obtained from experimental data obtained using a Hiden Isochema Sieverts rig at varying temperatures and hydrogen partial pressures. This modelling provided that at maximum practical hydration expected for V-based membranes (hydrogen to metal ratio (H/M) of ˜0.65, at 300 to 400° C. and up to partial pressure H₂ of 15 bara):
a maximum volumetric expansion of V-membranes up to the order of +15%; and
a maximum linear expansion (Eₕ) of V-membranes up to the order of +5%. In both cases, the degree of expansion varies as a function of H-absorption (i.e. absorbed hydrogen to metal or H/M ratio).

In order to incorporate this value into the expansion analysis a specific temperature-based coefficient (αₕ) for hydride expansion for vanadium was determined:

$${α}_{h} = \frac{{E}_{h}}{Δ T}$$

$${α}_{h} = \frac{5 * 1 {0}^{- 2}}{325 - 25} = 1.67 * 1 {0}^{- 4} \frac{m}{m K}$$

Combining with the known thermal expansion coefficient

$$( {a}_{t} = 8 * 1 {0}^{- 6} \frac{m}{m K} )$$

for vanadium, this gives a combined expansion coefficient αᵣ:

$${α}_{r} = {α}_{t} + {α}_{h}$$

$${α}_{r} = 8 * 1 {0}^{- 6} + 1.67 * 1 {0}^{- 4}$$

$${α}_{r} = 1.75 * 1 {0}^{- 4} \frac{m}{m K}$$

Once complete, the 325° C. steady state simulation's deformed geometry of an unconstrained membrane section was checked against expected total expansion (thermal and hydride) and was confirmed at ˜5.24%.

Detailed model outputs for stress components formed in critical sections of the membrane/fitting assembly were inspected and used to inform welding parameters and the design of the stress relieving collar, focused around reducing stress concentrations and minimising strain at the weld.

Hoop and axial stresses were obtained via standard outputs from the SolidWorks modelling software package (Version 2021 Service Pack 5.1 available from Dassault Systems SolidWorks Corporation, Waltham, Massachusetts, USA).

### Results

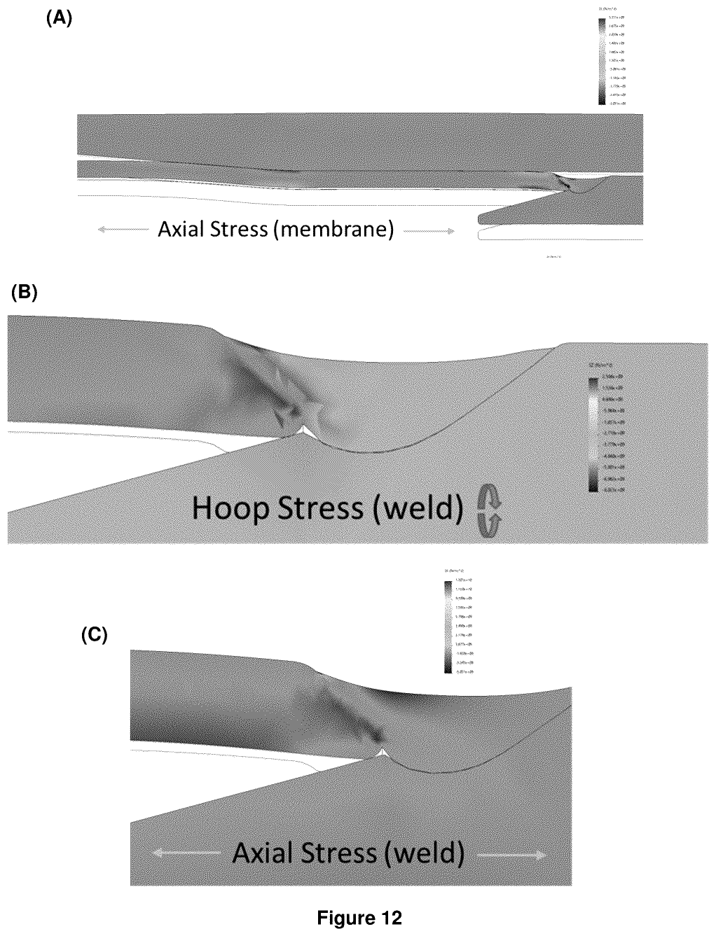

FIGS. 12 to 14(B) provide results of the Solidworks modelling of hydride lattice expansion and hoop and axial stresses.

FIG. 12 illustrates the modelled stress components on the membrane and the weld comprise axial and hoop stresses that are exerted on the vanadium-based membrane 110 and the welded connection 130 in both: Tension (positive); and Compression (negative).

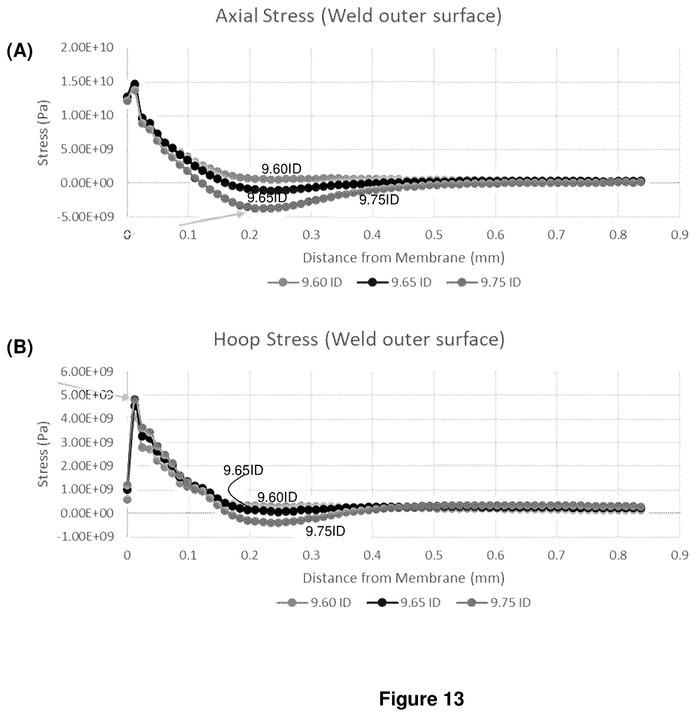

FIG. 13 illustrates the modelled results showing a plot of (A) axial stress of inner surface of the vanadium membrane at the connection interface vs distance from the welded connection; and (B) hoop stress of inner surface of the vanadium-based membrane 110 at the connection interface vs distance from the welded connection, for the joining and sealing arrangement 100 illustrated in FIGS. 1 to 3 when the vanadium-based membrane 110 is hydrogenated. The unhydrogenated outer diameter of the vanadium-based membrane 110 is 9.54 mm.

As shown in FIGS. 13(A) and 13(B), if the constriction collar's inner diameter is too large (loose fit—9.75ID) we see large compressive axial stresses and higher tensile stresses at the V-based membrane—fitting interface (welded connection). The experiments have found that collars at >9.75 mm fail consistently, and that the first of three membranes with 9.65 mm collars are still holding strong after at least 1000 hours of operation once the V-based membrane is hydrogenated—i.e. hydrogen permeation has begun.

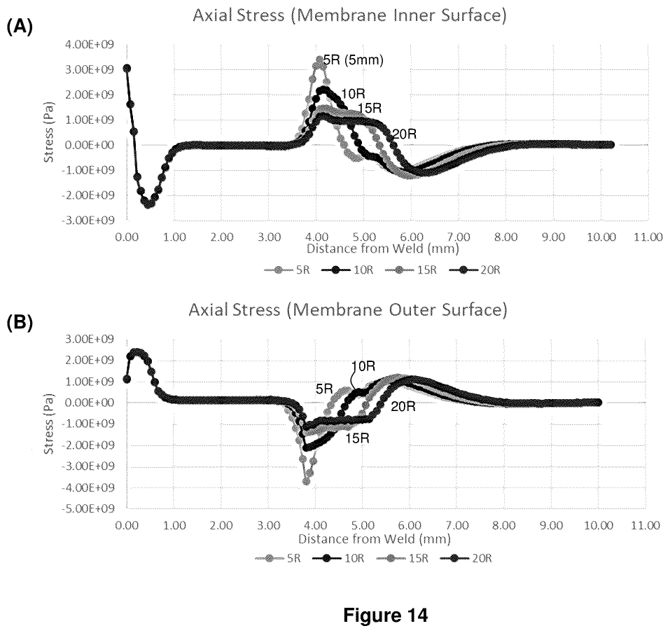

As shown in FIGS. 14(A) and 14(B), a smaller transition radius R concentrates the axial stress at that point and results in a significantly higher maximum stress on both the inner and outer faces of the vanadium-based membrane 110. The transition radius specification is therefore currently specified as 10 mm which is around 1× outer diameter of the vanadium-based membrane 110. However, moving to around 1.5× outer diameter of the vanadium-based membrane 110—i.e. 15 mm or higher would likely assist in reducing that stress concentration profile further.

### Example 3—Simulation of Stress Expansion Section for Different Expansion Angles

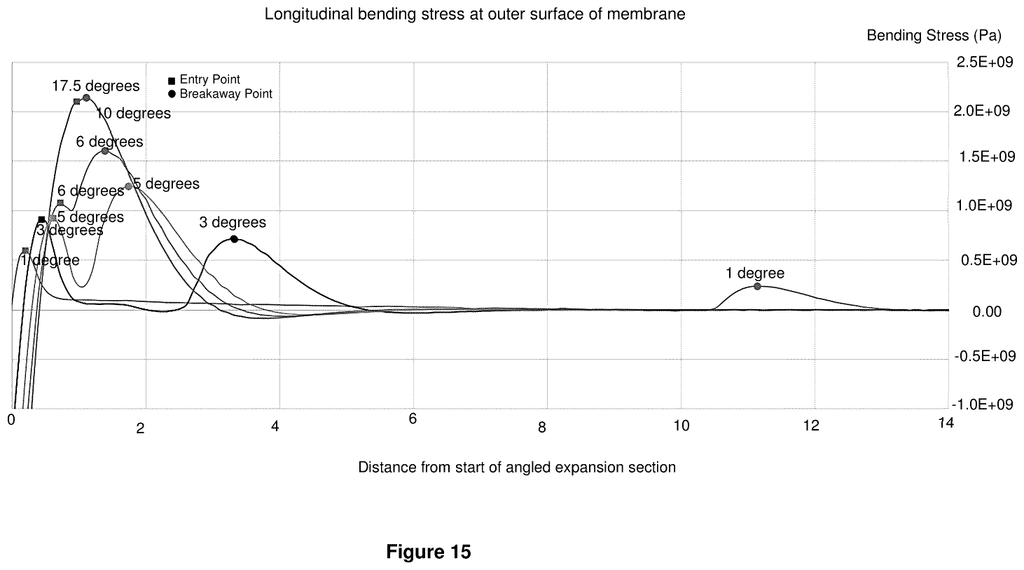

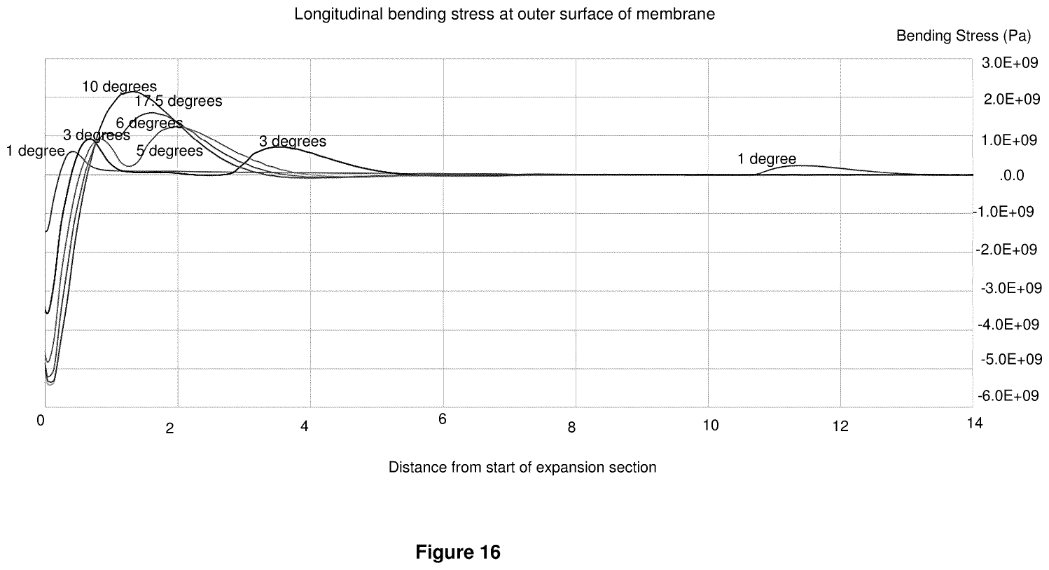

Modelling was conducted using Solidworks Simulation Professional (SSP) software package (Version 2021 Service Pack 5.1 available from Dassault Systems SolidWorks Corporation, Waltham, Massachusetts, USA) to determine the longitudinal bending stress in the expansion section of the collar illustrated in FIG. 1 for different average expansion angles. The modelling was done for a 5 mm transition radius (so ˜0.5 D). The results of stress modelling for the longitudinal bending stress at the outer surface of the membrane at average expansion angles of 0.5, 1, 3, 5, 6, 10, and 17.5 degrees is provided in FIGS. 15 and 16. FIG. 15 models the stresses from the end of the transition section, and FIG. 16 models the stresses from the start of the transition section. It should be noted that the lines for 10 and 17.5 degrees are exactly overlaid in the lines shown in FIG. 15, and are overlaid in FIG. 16 apart from a valley just after 0 mm.

As shown in FIGS. 15 and 16, a general rule appears to be that smaller angles of the angled section 145 provide better longitudinal stress results. However, this stress advantage needs to be balanced by the practical requirement of material waste. At very small angles, under 0.5 degrees for example, there is a substantive amount of waste material, covering a lot of membrane.

There are two stress peaks, for each average expansion angle, as best shown in FIG. 15:
A 1 st peak at an ‘entry point’, at the start of the tapered section (at the point where the transition section meets the angled section of the expansion section).
A 2nd peak at a ‘breakaway point’ where the membrane loses contact with the collar.

As shown in FIGS. 15 and 16, for small angles of the angled section 145 the peaks are spaced well apart. As the angle increases the peaks come together and superimpose to form an undesirably high peak stress.

### Example 4—Collar Internal Radius Rate of Expansion

The rate of expansion (mm/mm) of the expansion section of the collar was modelled for the distance from the start of the transition radius (mm) for a 5 mm radius transition section and expansion angles of 1, 3, 5, 6, 10, and 17.5 for the angled section 145, respectively, based on an expansion section as illustrated in FIG. 1. The rate of expansion increases along the transition section 148 from the constriction end until the rate of expansion reaches a maximum at the start of the angled section 145. The angled section 148 has a constant rate of expansion (it is a constant slope), which is the maximum rate of expansion of the expansion section 146.

The results are illustrated in FIG. 17. As shown, larger expansion angles of the angled section 145 (larger rates of expansion) require a longer transition section 148. This length depends on the intersecting tangent between the curve of the transition radius, and the slope of the angled section of the expansion section, and thus is greater for greater expansion angles.

The rate of radial expansion (mm/mm) of the different angled sections 145 modelled in FIG. 17 are the maximum rate of expansion for the respective expansion sections 146 of FIG. 17. The rate of expansion of the transition section 148 increases up to the maximum rate of expansion, which is at the point along the expansion section 146 where the transition section 148 meets the angled section 145.

The discussion above applies to the rate of radial expansion of the expansion section in mm/mm, but applies equally to the expansion angle of the expansion section 146. The expansion angle of the transition section 148 increases up to a maximum expansion angle, which is at the point along the expansion section 146 where the transition section 148 meets the angled section 145. The expansion angle of the angled section 145 can be considered the maximum expansion angle of the expansion section 146.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A joining and sealing arrangement for joining and sealing together a hydrogen separation membrane to a metallic connector comprising:
a metallic hydrogen separation membrane mounted on or against a connector formation of the connector about a longitudinal axis, the connector being formed of a different metal to the hydrogen separation membrane, the hydrogen separation membrane having an outer diameter (D) about the longitudinal axis, the hydrogen separation membrane and the connector formation contacting at a connection interface in which an end face of the hydrogen separation membrane is proximate to, substantially abuts or overlaps an adjoining face of the connector formation;
a connection that connects the hydrogen separation membrane and the connector formation about the connection interface; and
a constriction collar configured to extend from at least the connection interface and extend axially over the hydrogen separation membrane relative to the longitudinal axis, the constriction collar comprising:
an expansion section configured to axially extend over the hydrogen separation membrane relative to the longitudinal axis from a constriction end to an expanded diameter, the constriction end being configured to extend around the hydrogen separation membrane at or proximate the connection interface relative to the longitudinal axis and having an inner surface defining a constriction diameter (C) that is configured to extend around the outer surface of the hydrogen separation membrane,
wherein the expansion section includes a transition section that extends from the constriction end and comprises a curved surface having a transition radius of at least 0.1 D;
and wherein the expansion section comprises an angled or curved section in which the diameter of the constriction collar expands from the constriction diameter C to the expanded diameter comprising at least 1.01 D.

2. The joining and sealing arrangement according to claim 1, wherein the diameter of the constriction collar expands from the constriction diameter C to the expanded diameter constriction end at an average expansion angle relative to the longitudinal axis comprising one of: non-zero angle of less than 17.5 degrees; 0.5 to 6 degrees; or from 3 to 5 degrees.

3. The joining and sealing arrangement according to claim 1, wherein the constriction end comprises a constriction section configured to axially extend over the hydrogen separation membrane from the connection end relative to the longitudinal axis to the expansion section, the constriction section having an inner surface that extends around the longitudinal axis at the constriction diameter,
wherein the transition section extends from the transition between the constriction section and the expansion section,
and optionally wherein the inner surface of the of the constriction section is configured to be spaced apart, preferably substantially parallel spaced apart from the outer surface of the hydrogen separation membrane.

4. (canceled)

5. The joining and sealing arrangement according to claim 1, wherein the hydrogen separation membrane has an outer diameter D and the constriction diameter C comprises 0.95 D to 1.05 D, preferably 0.99 D to 1.05 D, more preferably 1 D to 1.05 D.

6. The joining and sealing arrangement according to claim 1, wherein the constriction section is configured to extend over the hydrogen separation membrane from the connection interface to the transition section for at least 0.25 D, preferably 0.25 D to 2D, more preferably 0.25 D to 1.5 D, more preferably 0.25 D to 1 D.

7. The joining and sealing arrangement according to claim 1, wherein the expanded diameter is at least 1.02 D, preferably at least 1.05 D, more preferably at least 1.1 D.

8. (canceled)

9. The joining and sealing arrangement according to claim 1, wherein the transition radius comprises from 0.1 D to 10 D, preferably from 0.5 D to 5 D, more preferably from 1 D to 5 D.

10. The joining and sealing arrangement according to claim 1, wherein the expansion section extends at least one of: at least 0.2 D relative to the longitudinal axis; at least 0.3 D relative to the longitudinal axis; at least 0.4 D relative to the longitudinal axis; or at least 0.5 D relative to the longitudinal axis.

11. (canceled)

12. The joining and sealing arrangement according to claim 1, wherein the outer diameter (D) of the hydrogen separation membrane is between 2 to 25 mm, preferably between 5 and 20 mm, and has a wall thickness of from 0.05 to 1 mm, preferably from 0.1 to 1 mm.

13. The joining and sealing arrangement according to claim 1, wherein the constriction collar is configured to extend over the connection interface of the hydrogen separation membrane to a collar fastening section configured to fasten onto a section of the connector, the collar fastening section includes a fastening formation configured to interconnect the constriction collar to a cooperative fastening formation of the connector, and optionally wherein the fastening formation comprises a threaded connection which is configured to cooperatively fasten onto a thread located on the connector.

14. (canceled)

15. The joining and sealing arrangement according to claim 1, wherein the constriction collar further comprises an end cap configured to form an end seal around the connector.

16. The joining and sealing arrangement according to claim 1, in which:
the connector includes a tubular extension extending longitudinally away from the connection interface, and
the constriction collar includes a sealing section configured to extend over the tubular extension of the connector to a distal fastening end,
wherein the constriction collar further includes a compression fitting configured to fasten to the distal fastening end of the sealing section, the compression fitting including at least one ferrule configured to seal around a section of the tubular extension of the connector when the compression fitting is fastened onto the distal fastening end of the sealing section.

17. The joining and sealing arrangement according to claim 16, wherein the at least one ferrule comprises a graphite ferrule, optionally the compression fitting comprises a sealing nut configured to be threadedly fastened to the distal fastening end of the sealing section, and optionally the sealing section includes a fastening formation configured to interconnect the constriction collar to a cooperative fastening formation of the connector.

18. (canceled)

19. (canceled)

20. (canceled)

21. (canceled)

22. The joining and sealing arrangement according to claim 1, wherein the hydrogen separation membrane comprises a group V based metal or metal alloy, preferably a vanadium, tantalum or niobium metal or metal alloy, more preferably vanadium or a vanadium alloy, optionally the hydrogen separation membrane comprises a vanadium alloy comprising: vanadium; aluminium having a content of greater than 0 to 10 at %; and Ta content of less than 0.01 at %, having a ductility of greater than 10% elongation, preferably greater than 11% elongation, and optionally the hydrogen separation membrane is coated in a Pd based coating or a Pd—Au based coating.

23. (canceled)

24. (canceled)

25. (canceled)

26. (canceled)

27. (canceled)

28. (canceled)

29. The joining and sealing arrangement according to claim 1, wherein the connector formation comprises a sloped or bevelled section configured to receive the end section of the hydrogen separation membrane thereon.

30. The joining and sealing arrangement according to claim 1, wherein the connection comprises a welded connection, and optionally the welded connection comprises a continuous weld which extends circumferentially around and over the connection interface.

31. (canceled)

32. (canceled)

33. A method of joining and sealing a hydrogen separation membrane to a metallic connector comprising:
mounting an end section of a metallic hydrogen separation membrane on or against a connector formation of a connector, the connector being formed of a different metal to the hydrogen separation membrane, the hydrogen separation membrane having an outer diameter (D) about the longitudinal axis, the hydrogen separation membrane and the connector formation contacting at a connection interface in which an end face of the hydrogen separation membrane is proximate to, substantially abuts or overlaps an adjoining face of the connector formation;
joining the hydrogen separation membrane to the connector formation to join and seal the hydrogen separation membrane to the connector over the connection interface; and
locating a constriction collar over the hydrogen separation membrane to extend from at least the connection interface and extend axially over the hydrogen separation membrane relative to the longitudinal axis,
wherein the constriction collar comprises: an expansion section configured to axially extend over the hydrogen separation membrane relative to the longitudinal axis from a constriction end to an expanded diameter, the constriction end being configured to extend around the hydrogen separation membrane at or proximate the connection interface relative to the longitudinal axis and having an inner surface defining a constriction diameter (C) that is configured to extend around the outer surface of the hydrogen separation membrane; the expansion section including a transition section that extends from the constriction end and comprises a curved surface having a transition radius of at least 0.1 D,
and wherein the expansion section comprises an angled or curved section in which the diameter of the constriction collar expands from the constriction diameter C to the expanded diameter comprising at least 1.01 D.

34. The method according to claim 33, using a joining and sealing arrangement according to claim 1.

35. (canceled)

36. (canceled)

37. (canceled)

38. (canceled)

39. (canceled)

40. (canceled)

41. (canceled)

42. (canceled)

43. (canceled)

44. A hydrogen separation membrane constriction collar configured to extend over a hydrogen separation membrane, the constriction collar being configured to extend from a connection interface between the hydrogen separation membrane and a connector and over the hydrogen separation membrane, the constriction collar having a longitudinal axis and comprising:
an expansion section configured to axially extend over the hydrogen separation membrane relative to the longitudinal axis from a constriction end to an expanded diameter, the constriction end being configured to extend around the hydrogen separation membrane at or proximate the connection interface relative to the longitudinal axis and having an inner surface defining a constriction diameter (C) that is configured to extend around the outer surface of the hydrogen separation membrane
wherein the expansion section includes a transition section that extends from the constriction end and comprises a curved surface having a transition radius of at least 0.1 C,
and wherein the expansion section comprises an angled or curved section that extends from the transition section in which:
the diameter of the constriction collar expands from the constriction diameter to the expanded diameter with an average expansion angle relative to the longitudinal axis of the angled or curved section comprising a non-zero angle less than 17.5 degrees, and the expanded diameter comprises at least 1.01 C.

45. The constriction collar according to claim 44, comprising at least one of the following:
wherein the expansion section extends at least 0.2 C relative to the longitudinal axis;
wherein the hydrogen separation membrane has an outer diameter D, and the constriction diameter C comprises 0.95 D to 1.05 D, preferably 0.99 D to 1.05 D, more preferably 1 D to 1.05 D;
wherein the constriction section is configured to extend over the hydrogen separation membrane from the connection interface to the transition section for at least 0.25 C, preferably 0.25 C to 2 C, more preferably 0.25 C to 1.5 C, more preferably 0.25 C to 1 C;
wherein the expanded diameter is at least 1.02 C, preferably at least 1.05 C, more preferably at least 1.1 C
wherein the average expansion angle is from 0.5 to 6 degrees, preferably from 3 to 5 degrees
wherein the transition radius comprises from 0.1 C to 1° C., preferably from 0.5 C to 5 C, more preferably from 1 C to 5 C
wherein the expansion section extends at least 0.3 C, preferably at least 0.4 C, more preferably at least 0.5 C relative to the longitudinal axis.

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)
